(19) United States
(12) Patent Application Publication
(10) Pub. No.: US 2025/0046963 A1
(43) Pub. Date: Feb. 6, 2025

(54) BATTERY AND METHOD OF MANUFACTURING SAME

(71) Applicant: Panasonic Intellectual Property Management Co., Ltd., Osaka (JP)

(72) Inventors: AKIRA KAWASE, Osaka (JP); NORIYUKI UCHIDA, Osaka (JP)

(21) Appl. No.: 18/924,254

(22) Filed: Oct. 23, 2024

Related U.S. Application Data
(63) Continuation of application No. PCT/JP2022/045205, filed on Dec. 8, 2022.

(30) Foreign Application Priority Data
May 16, 2022 (JP) 2022-080088
May 16, 2022 (JP) 2022-080089
Nov. 18, 2022 (JP) 2022-184814

(51) Int. Cl. H01M 50/54; H01M 10/0585; H01M 50/211; H01M 50/296; H01M 50/51; H01M 50/512

(52) U.S. Cl. CPC H01M 50/54; H01M 10/0585; H01M 50/211; H01M 50/296; H01M 50/51; H01M 50/512

(57) ABSTRACT

A battery according to the present disclosure includes: a power-generation element including a battery cell including an electrode layer, a counter-electrode layer, and a separator located between the electrode layer and the counter-electrode layer, and an electrode current collector laminated on the electrode layer; and a first core member, the electrode current collector includes an electrode terminal portion protruding outside the area of the electrode layer, and the electrode terminal portion is wound around the first core member.

### BACKGROUND

### 1. Technical Field

The present disclosure relates to a battery and a method of manufacturing the same.

### 2. Description of the Related Art

Japanese Unexamined Patent Application Publication No. 2004-055335 discloses a laminated battery in which end portions of the outer case are wound around core material members.

Japanese Patent No. 5430591 discloses a laminated battery in which current collectors are wound and connected to lead lines.

### SUMMARY

One non-limiting and exemplary embodiment provides a battery with high energy density and a method of manufacturing the same.

In one general aspect, the techniques disclosed here feature a battery including: a power-generation element including a battery cell including an electrode layer, a counter-electrode layer, and a separator located between the electrode layer and the counter-electrode layer, and an electrode current collector laminated on the electrode layer; and a first core member, in which the electrode current collector includes an electrode terminal portion protruding outside the area of the electrode layer, and the electrode terminal portion is wound around the first core member.

The present disclosure makes it possible to provide a battery with high energy density and a method of manufacturing the same.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a plan view of a battery according to Embodiment 1;

FIG. 2 is an enlarged perspective view of an end portion and its vicinity of the battery according to Embodiment 1;

FIG. 3 is a plan view of a power-generation element of the battery according to Embodiment 1 before core members are attached to it;

FIG. 4 is a cross-sectional view of the power-generation element of the battery according to Embodiment 1 before the core members are attached to it;

FIG. 5 is an enlarged cross-sectional view of the end portion and its vicinity of the battery according to Embodiment 1;

FIG. 6 is a plan view of a battery according to Embodiment 2;

FIG. 7 is an enlarged perspective view of an end portion and its vicinity of the battery according to Embodiment 2;

FIG. 8 is an enlarged cross-sectional view of the end portion and its vicinity of the battery according to Embodiment 2;

FIG. 9A is a cross-sectional view of a shaft portion of a core member according to Modification Example 1;

FIG. 9B is a cross-sectional view of the shaft portion of the core member according to Modification Example 1 and electrode terminal portions wound around the shaft portion;

FIG. 9C is a cross-sectional view of the shaft portion and a tubular portion of the core member according to Modification Example 1 and the electrode terminal portions wound around the shaft portion;

FIG. 10A is a cross-sectional view of a shaft portion of a core member according to Modification Example 2;

FIG. 10B is a cross-sectional view of the shaft portion of the core member according to Modification Example 2 and electrode terminal portions wound around the shaft portion;

FIG. 10C is a cross-sectional view of the shaft portion and a tubular portion of the core member according to Modification Example 2 and the electrode terminal portions wound around the shaft portion;

FIG. 11A is a cross-sectional view of a shaft portion of a core member according to Modification Example 3;

FIG. 11B is a cross-sectional view of the shaft portion of the core member according to Modification Example 3 and electrode terminal portions wound around the shaft portion;

FIG. 11C is a cross-sectional view of the shaft portion and a tubular portion of the core member according to Modification Example 3 and the electrode terminal portions wound around the shaft portion;

FIG. 12A is a cross-sectional view of a shaft portion of a core member according to Modification Example 4;

FIG. 12B is a cross-sectional view of the shaft portion of the core member according to Modification Example 4 and electrode terminal portions wound around the shaft portion;

FIG. 12C is a cross-sectional view of the shaft portion and a tubular portion of the core member according to Modification Example 4 and the electrode terminal portions wound around the shaft portion;

FIG. 13A is a cross-sectional view of a shaft portion of a core member according to Modification Example 5;

FIG. 13B is a cross-sectional view of the shaft portion of the core member according to Modification Example 5 and electrode terminal portions wound around the shaft portion;

FIG. 13C is a cross-sectional view of the shaft portion and a tubular portion of the core member according to Modification Example 5 and the electrode terminal portions wound around the shaft portion;

FIG. 14A is a cross-sectional view of a shaft portion of a core member according to Modification Example 6;

FIG. 14B is a cross-sectional view of the shaft portion of the core member according to Modification Example 6 and electrode terminal portions wound around the shaft portion;

FIG. 14C is a cross-sectional view of the shaft portion and a tubular portion of the core member according to Modification Example 6 and the electrode terminal portions wound around the shaft portion;

FIG. 15A is a cross-sectional view of a shaft portion of a core member according to Modification Example 7;

FIG. 15B is a cross-sectional view of the shaft portion of the core member according to Modification Example 7 and electrode terminal portions wound around the shaft portion;

FIG. 15C is a cross-sectional view of the shaft portion and a tubular portion of the core member according to Modification Example 7 and the electrode terminal portions wound around the shaft portion;

FIG. 16A is a cross-sectional view of a shaft portion of a core member according to Modification Example 8;

FIG. 16B is a cross-sectional view of the shaft portion of the core member according to Modification Example 8 and electrode terminal portions wound around the shaft portion;

FIG. 16C is a cross-sectional view of the shaft portion and a tubular portion of the core member according to Modification Example 8 and the electrode terminal portions wound around the shaft portion;

FIG. 17A is a cross-sectional view of a shaft portion of a core member according to Modification Example 9;

FIG. 17B is a cross-sectional view of the shaft portion of the core member according to Modification Example 9 and electrode terminal portions wound around the shaft portion;

FIG. 17C is a cross-sectional view of the shaft portion and a tubular portion of the core member according to Modification Example 9 and the electrode terminal portions wound around the shaft portion;

FIG. 18A is a cross-sectional view of a shaft portion of a core member according to Modification Example 10;

FIG. 18B is a cross-sectional view of the shaft portion of the core member according to Modification Example 10 and electrode terminal portions wound around the shaft portion;

FIG. 18C is a cross-sectional view of the shaft portion and a tubular portion of the core member according to Modification Example 10 and the electrode terminal portions wound around the shaft portion;

FIG. 19A is a cross-sectional view of a shaft portion of a core member according to Modification Example 11;

FIG. 19B is a cross-sectional view of the shaft portion of the core member according to Modification Example 11 and electrode terminal portions wound around the shaft portion;

FIG. 19C is a cross-sectional view of the shaft portion and a tubular portion of the core member according to Modification Example 11 and the electrode terminal portions wound around the shaft portion;

FIG. 20A is a cross-sectional view of a shaft portion of a core member according to Modification Example 12;

FIG. 20B is a cross-sectional view of the shaft portion of the core member according to Modification Example 12 and electrode terminal portions wound around the shaft portion;

FIG. 20C is a cross-sectional view of the shaft portion and a tubular portion of the core member according to Modification Example 12 and the electrode terminal portions wound around the shaft portion;

FIG. 21A is a cross-sectional view of a shaft portion of a core member according to Modification Example 13;

FIG. 21B is a cross-sectional view of the shaft portion of the core member according to Modification Example 13 and electrode terminal portions wound around the shaft portion;

FIG. 21C is a cross-sectional view of the shaft portion and a tubular portion of the core member according to Modification Example 13 and the electrode terminal portions wound around the shaft portion;

FIG. 22A is a perspective view of a core member according to Modification Example 14;

FIG. 22B is a perspective view of a core member according to Modification Example 14;

FIG. 23A is a plan view of a battery according to a modification example of Embodiment 1;

FIG. 23B is a plan view of a battery according to a modification example of Embodiment 2;

FIG. 24A is a plan view of a battery according to another modification example of Embodiment 1;

FIG. 24B is a plan view of a battery according to another modification example of Embodiment 2;

FIG. 25 is a plan view of a battery according to Embodiment 3;

FIG. 26 is a plan view of a power-generation element of the battery according to Embodiment 3 before core members are attached to it;

FIG. 27 is a plan view of a battery according to Embodiment 3;

FIG. 28A is a plan view of a battery according to a modification example of Embodiment 3;

FIG. 28B is a plan view of a battery according to a modification example of Embodiment 3;

FIG. 29A is a plan view of a battery according to another modification example of Embodiment 3;

FIG. 29B is a plan view of a battery according to another modification example of Embodiment 3;

FIG. 30 is a cross-sectional view of a power-generation element of a battery according to a modification example of each embodiment before core members are attached to it;

FIG. 31A is a cross-sectional diagram for explaining a step of attaching a core member in a battery according to a modification example of each embodiment;

FIG. 31B is a cross-sectional diagram for explaining a step of attaching the core member in the battery according to the modification example of each embodiment; and

FIG. 31C is a cross-sectional diagram for explaining a step of attaching the core member in the battery according to the modification example of each embodiment.

### DETAILED DESCRIPTIONS

### Overview of Present Disclosure

The following shows a plurality of examples of the battery and the method of manufacturing the same according to the present disclosure.

The battery according to a first aspect of the present disclosure includes:
a power-generation element including
   a battery cell including an electrode layer, a counter-electrode layer, and a separator located between the electrode layer and the counter-electrode layer, and
   an electrode current collector laminated on the electrode layer; and
a first core member,
the electrode current collector includes an electrode terminal portion protruding outside the area of the electrode layer, and
the electrode terminal portion is wound around the first core member.

Since the electrode terminal portion is wound around the first core member as described above, the electrode terminal portion can be stored compactly. Since the electrode terminal portion is stored compactly, the portions contributing to charging and discharging can be made relatively large. This increases the energy density of the battery.

As a second aspect the present disclosure, for example, the battery according to the first aspect may further include
a second core member,
the power-generation element may include a counter-electrode current collector laminated on the counter-electrode layer,
the counter-electrode current collector may include a counter-electrode terminal portion protruding outside the area of the counter-electrode layer, and
the counter-electrode terminal portion may be wound around the second core member.

Since the counter-electrode terminal portion is wound around the second core member as described above, the counter-electrode terminal portion can be stored compactly. Since the counter-electrode terminal portion is stored compactly, the portions contributing to charging and discharging can be made relatively large. This increases the energy density of the battery.

As a third aspect of the present disclosure, for example, in the battery according to the second aspect,
a protruding direction of the counter-electrode terminal portion may differ from a protruding direction of the electrode terminal portion.

This configuration enables the electrode terminal portion and the counter-electrode terminal portion to be located away from each other. Since this prevents the occurrence of a short circuit due to contact between the electrode terminal portion and the counter-electrode terminal portion, it is possible to provide a battery with high reliability.

As a fourth aspect of the present disclosure, for example, in the battery according to the second aspect,
a protruding direction of the counter-electrode terminal portion may be the same as a protruding direction of the electrode terminal portion, and
the first core member and the second core member may be integrated with an insulating member interposed in between.

Since this configuration enables the first core member and the second core member to be integrated, the electrode terminal portion and the counter-electrode terminal portion can be stored more compactly. Thus, it is possible to further increase the energy density of the battery. In addition, since the electrode terminal portion and the counter-electrode terminal portion can be wound simultaneously, it simplifies the manufacturing steps of the battery, increasing the productivity.

As a fifth aspect of the present disclosure, for example, in the battery according to any one of the second to fourth aspects,
the power-generation element may include a plurality of the battery cells,
the plurality of battery cells may be electrically connected in parallel and laminated, and
one of the electrode current collector and the counter-electrode current collector may be located between each pair of adjacent ones of the battery cells.

Since this configuration enables the plurality of battery cells to be placed compactly, it increases the energy density of the battery.

As a sixth aspect of the present disclosure, for example, in the battery according to the fifth aspect,
the power-generation element may include a plurality of the electrode current collectors and a plurality of the counter-electrode current collectors,
the electrode terminal portions of the plurality of electrode current collectors may be laminated on top of one another and wound around the first core member, and
the counter-electrode terminal portions of the plurality of counter-electrode current collectors may be laminated on top of one another and wound around the second core member.

With this configuration, the plurality of electrode terminal portions and the plurality of counter-electrode terminal portions enable the plurality of battery cells to be connected in parallel. Since the portions related to parallel connection can be small, it increases the energy density of the battery.

As a seventh aspect of the present disclosure, for example, in the battery according to any one of the second to fourth aspects,
the power-generation element may include a plurality of series units, each series unit including a specified number of the battery cells electrically connected in series and laminated,
the series units may be electrically connected in parallel and laminated, and
one of the electrode current collector and the counter-electrode current collector may be located between each pair of adjacent ones of the series units.

Since the power-generation element includes the series units in this configuration,
a high voltage can be outputted.

As an eighth aspect of the present disclosure, for example, in the battery according to the seventh aspect,
the power-generation element may include a plurality of the electrode current collectors and a plurality of the counter-electrode current collectors,
the electrode terminal portions of the plurality of electrode current collectors may be laminated on top of one another and wound around the first core member, and
the counter-electrode terminal portions of the plurality of counter-electrode current collectors may be laminated on top of one another and wound around the second core member.

With this configuration, the plurality of electrode terminal portions and the plurality of counter-electrode terminal portions enable the plurality of battery cells to be connected in parallel. Since the portions related to parallel connection can be small, it increases the energy density of the battery.

As a ninth aspect of the present disclosure, for example, in the battery according to any one of the first to eighth aspects,
the first core member may include a conductive portion electrically connected to the electrode terminal portion.

This configuration enables part of the first core member to be used as a current output path from the battery. Since the part count can be smaller than in the configuration including another dedicated member, it simplifies the manufacturing steps of the battery, increasing the productivity of the battery.

As a tenth aspect of the present disclosure, for example, in the battery according to the ninth aspect,
the first core member may include an outer connection terminal having electrical conductivity and extending in a specified direction from the conductive portion.

This configuration enables part of the first core member to be used for connection to another device. Since the part count can be smaller than in the configuration including another dedicated member, it simplifies the manufacturing steps of the battery, increasing the productivity of the battery.

As an eleventh aspect of the present disclosure, for example, in the battery according to the tenth aspect,
the outer connection terminal may extend from an end portion in an axial direction of the first core member, in the axial direction.

As a twelfth aspect of the present disclosure, for example, in the battery according to the tenth aspect,
the outer connection terminal may extend from a surface of the first core member opposite to the power-generation element in a direction away from the power-generation element.

As mentioned above, an outer connection terminal can be provided so as to extend in various directions depending on what the battery is connected to. This increases the ease of mounting of the battery.

As a thirteenth aspect of the present disclosure, for example, the battery according to any one of the first to twelfth aspects may further include
an outer case housing the battery cell and the electrode current collector, and
at least part of the first core member may be housed in the outer case.

Since at least part of the first core member is housed in the outer case together with the power-generation element in this configuration, the electrode terminal portion can be stored compactly. This increases the energy density of the battery. In addition, since the outer case protects the power-generation element, it is possible to increase the reliability of the battery.

As a fourteenth aspect of the present disclosure, for example, in the battery according to any one of the first to thirteenth aspects,
the thickness of the first core member may be smaller than the thickness of the power-generation element.

This configuration enables the electrode terminal portion to be stored compactly.

This increases the energy density of the battery.

As a fifteenth aspect of the present disclosure, for example, in the battery according to any one of the first to fourteenth aspects,
the first core member may include
   a first shaft member having a first surface extending in an axial direction of the first core member and
   a second shaft member having a second surface facing the first surface and extending in the axial direction, and
part of the electrode terminal portion may be held between the first surface and the second surface.

This configuration enables the electrode terminal portion to be firmly fixed to the first core member. This makes it less likely that the electrode terminal portion will come off the first core member, increasing the reliability of the battery.

As a sixteenth aspect of the present disclosure, for example, in the battery according to the fifteenth aspect,
the first surface may have a first recess or a first protrusion, and
the second surface may have a second protrusion that fits with the first recess or a second recess that fits with the first protrusion.

This configuration enables the electrode terminal portion to be fixed more firmly to the first core member. This makes it less likely that the electrode terminal portion will come off the first core member, further increasing the reliability of the battery.

As a seventeenth aspect of the present disclosure, for example, in the battery according to the fifteenth or sixteenth aspect,
the first core member may include a ring-shaped member into which the first shaft member and the second shaft member are inserted with the first surface and the second surface facing each other.

This configuration enables the two shaft members to be firmly fixed. This makes it less likely that the electrode terminal portion will come off the first core member, increasing the reliability of the battery.

As an eighteenth aspect of the present disclosure, for example, in the battery according to any one of the first to seventeenth aspects,
the first core member may have a circular cylinder shape, an elliptical cylinder shape, or a polygonal cylinder shape.

This configuration simplifies the structure of the first core member, increasing the productivity.

As a nineteenth aspect of the present disclosure, for example, in the battery according to any one of the first to eighteenth aspects, an outer peripheral side surface of the first core member may have a flat surface parallel to a thickness direction of the power-generation element, on a side opposite to the power-generation element.

Since this configuration enables the electrode terminal portion to be stored more compactly, it increases the energy density of the battery.

As a twentieth aspect of the present disclosure, for example, in the battery according to any one of the first to nineteenth aspects,
the separator may be a solid electrolyte layer.

This configuration makes it possible to provide an all-solid-state battery with high energy density.

As a twenty-first aspect of the present disclosure, for example, in the battery according to any one of the first to twentieth aspects,
the first core member may include a first shaft portion and a first tubular portion in which the first shaft portion is located,
the first tubular portion may have a first opening extending in an axial direction of the first shaft portion, and
the electrode terminal portion may pass through the first opening and be wound around the first shaft portion.

Since this configuration enables the wound electrode terminal portion to be covered with the first tubular portion, it is possible to protect the electrode terminal portion and increase the reliability of the battery.

A method of manufacturing a battery, according to a twenty-second aspect of the present disclosure includes
winding the electrode terminal portion of the battery around the first core member.

Since the electrode terminal portion is wound around the first core member in this method, the electrode terminal portion can be stored compactly. Since the electrode terminal portion is stored compactly, the portions contributing to charging and discharging can be made relatively large. This makes it possible to manufacture a battery with high energy density.

A battery according to a twenty-third aspect of the present disclosure includes:
a power-generation element including
   a battery cell including an electrode layer, a counter-electrode layer, and
a separator located between the electrode layer and the counter-electrode layer, and
   an electrode current collector laminated on the electrode layer; and
a first core member including a first shaft portion and a first tubular portion in which the first shaft portion located,
the first tubular portion has a first opening extending in an axial direction of the first shaft portion,
the electrode current collector includes an electrode terminal portion protruding outside the area of the electrode layer, and
the electrode terminal portion passes through the first opening and is wound around the first shaft portion.

Since the electrode terminal portion is wound around the first shaft portion as described above, the electrode terminal portion can be stored compactly. Since the electrode terminal portion is stored compactly, the portions contributing to charging and discharging can be made relatively large. This increases the energy density of the battery. In addition, since this configuration enables the wound electrode terminal portion to be covered with the first tubular portion, it is possible to protect the electrode terminal portion and increase the reliability of the battery.

As a twenty-fourth aspect of the present disclosure, for example, in the battery according to the twenty-third aspect,
the power-generation element may include a counter-electrode current collector laminated on the counter-electrode layer,
the counter-electrode current collector may include a counter-electrode terminal portion protruding outside the area of the counter-electrode layer,
the battery may further include a second core member including a second shaft portion and a second tubular portion in which the second shaft portion is located,
the second tubular portion may have a second opening extending in an axial direction of the second shaft portion, and
the counter-electrode terminal portion may pass through the second opening and be wound around the second shaft portion.

Since the counter-electrode terminal portion is wound around the second shaft portion as described above, the counter-electrode terminal portion can be stored compactly. Since the counter-electrode terminal portion is stored compactly, the portions contributing to charging and discharging can be made relatively large. This increases the energy density of the battery. In addition, since this configuration enables the wound counter-electrode terminal portion to be covered with the second tubular portion, it is possible to protect the counter-electrode terminal portion and increase the reliability of the battery.

As a twenty-fifth aspect of the present disclosure, for example, in the battery according to the twenty-fourth aspect,
a protruding direction of the counter-electrode terminal portion may differ from a protruding direction of the electrode terminal portion.

This configuration enables the electrode terminal portion and the counter-electrode terminal portion to be located away from each other. Since this prevents the occurrence of a short circuit due to contact between the electrode terminal portion and the counter-electrode terminal portion, it is possible to provide a battery with high reliability.

As a twenty-sixth aspect of the present disclosure, for example, in the battery according to the twenty-fourth aspect,
a protruding direction of the counter-electrode terminal portion may be the same as a protruding direction of the electrode terminal portion, and
the first shaft portion and the second shaft portion may be integrated with an insulating member interposed in between.

Since the first shaft portion and the second shaft portion are integrated in this configuration, the electrode terminal portion and the counter-electrode terminal portion can be stored more compactly. Thus, it is possible to further increase the energy density of the battery. In addition, since the electrode terminal portion and the counter-electrode terminal portion can be wound simultaneously, it simplifies the manufacturing steps of the battery, increasing the productivity.

As a twenty-seventh aspect of the present disclosure, for example, in the battery according to any one of the twenty-fourth to twenty-sixth aspects,
the power-generation element may include a plurality of the battery cells,
the plurality of battery cells may be electrically connected in parallel and laminated, and
one of the electrode current collector and the counter-electrode current collector may be located between each pair of adjacent ones of the battery cells.

Since this configuration enables the plurality of battery cells to be placed compactly, it increases the energy density of the battery.

As a twenty-eighth aspect of the present disclosure, for example, in the battery according to any one of the twenty-fourth to twenty-sixth aspects,
the power-generation element may include a plurality of series units, each series unit including a specified number of the battery cells electrically connected in series and laminated,
the series units may be electrically connected in parallel and laminated, and
one of the electrode current collector and the counter-electrode current collector may be located between each pair of adjacent ones of the series units.

Since the power-generation element includes the series units in this configuration,
a high voltage can be outputted.

As a twenty-ninth aspect of the present disclosure, for example, in the battery according to the twenty-seventh or twenty-eighth aspect,
the power-generation element may include a plurality of the electrode current collectors and a plurality of the counter-electrode current collectors,
the electrode terminal portions of the plurality of electrode current collectors may be laminated on top of one another and may pass through the first opening and be wound around the first shaft portion, and
the counter-electrode terminal portions of the plurality of counter-electrode current collectors may be laminated on top of one another and may pass through the second opening and be wound around the second shaft portion.

With this configuration, the plurality of electrode terminal portions and the plurality of counter-electrode terminal portions enable the plurality of battery cells to be connected in parallel. Since the portions related to parallel connection can be small, it increases the energy density of the battery. Since the plurality of electrode terminal portions pass through the first opening of the first tubular portion, it reduces the difference in the path length around the first shaft portion between the plurality of electrode terminal portions. Since the difference in the path length between the plurality of electrode terminal portions is small, it is possible to wind the plurality of electrode terminal portions around the first shaft portion easily and firmly. This increases the reliability of the battery. Since the same is true of the counter-electrode terminal portions, it further increases the reliability of the battery.

As a thirtieth aspect of the present disclosure, for example, in the battery according to the twenty-ninth aspect,
at least one of the electrode terminal portions may be in contact with an opening end of the first opening, and
at least one the counter-electrode terminal portions may be in contact with an opening end of the second opening.

This configuration enables the paths of the electrode terminal portions to be controlled by bringing the electrode terminal portion into contact with the opening end. This reduces the difference in the path length between the plurality of electrode terminal portions.

As a thirty-first aspect of the present disclosure, for example, in the battery according to the twenty-ninth or thirtieth aspect,
the lengths of the plurality of electrode terminal portions may be the same as one another, and
the lengths of the plurality of counter-electrode terminal portions may be the same as one another.

Since the sizes of the plurality of electrode terminal portions are the same in this configuration, it makes the processing easy, increasing the productivity of the battery. Since the same is true of the counter-electrode terminal portions, it further increases the productivity of the battery.

As a thirty-second aspect of the present disclosure, for example, in the battery according to the twenty-third to thirty-first aspects,
the first shaft portion may have a conductive portion electrically connected to the electrode terminal portion.

This configuration enables part of the first shaft portion to be used as a current output path from the battery. Since the part count can be smaller than in the configuration including another dedicated member, it simplifies the manufacturing steps of the battery, increasing the productivity of the battery.

As a thirty-third aspect of the present disclosure, for example, in the battery according to the thirty-second aspect,
the first core member may include an outer connection terminal having electrical conductivity and extending in a specified direction from the conductive portion.

This configuration enables part of the first core member to be used for connection to another device. Since the part count can be smaller than in the configuration including another dedicated member, it simplifies the manufacturing steps of the battery, increasing the productivity of the battery.

As a thirty-fourth aspect of the present disclosure, for example, the battery according to any one of the twenty-third to thirty-third aspects may include
an outer case housing the battery cell and the electrode current collector, and
at least part of the first core member may be housed in the outer case.

Since at least part of the first core member is housed in the outer case together with the power-generation element in this configuration, the electrode terminal portion can be stored compactly. This increases the energy density of the battery. In addition, since the outer case protects the power-generation element, it is possible to increase the reliability of the battery.

As a thirty-fifth aspect of the present disclosure, for example, in the battery according to any one of the twenty-third to thirty-fourth aspects,
the thickness of the first core member may be smaller than the thickness of the power-generation element.

This configuration enables the electrode terminal portion to be stored compactly. This increases the energy density of the battery.

As a thirty-sixth aspect of the present disclosure, for example, in the battery according to any one of the twenty-third to thirty-fifth aspects,
the first shaft portion may have a groove into which the distal end of the electrode terminal portion is inserted.

This prevents the electrode terminal portion from peeling off and coming apart from the distal end, increasing the reliability of the battery.

As a thirty-seventh aspect of the present disclosure, for example, in the battery according to any one of the twenty-third to thirty-sixth aspects,
the first shaft portion may include
   a first shaft member having a first surface extending in an axial direction of the first shaft portion and
   a second shaft member having a second surface facing the first surface and extending in the axial direction, and
part of the electrode terminal portion may be held between the first surface and the second surface.

This configuration enables the electrode terminal portion to be firmly fixed. This makes it less likely that the electrode terminal portion will come off the first core member, further increasing the reliability of the battery.

As a thirty-eighth aspect of the present disclosure, for example, in the battery according to the thirty-seventh aspect,
the first surface may have a first recess or a first protrusion, and
the second surface may have a second protrusion that fits with the first recess or a second recess that fits with the first protrusion.

This configuration enables the electrode terminal portion to be fixed more firmly. Since this makes it less likely that the electrode terminal portion will come off the first core member, it further increases the reliability of the battery.

As a thirty-ninth aspect of the present disclosure, for example, in the battery according to the thirty-seventh or thirty-eighth aspect,
the first core member may include a ring-shaped member into which the first shaft member and the second shaft member are inserted with the first surface and the second surface facing each other.

This configuration enables the two shaft members to be firmly fixed. This makes it less likely that the electrode terminal portion will come off the first core member, increasing the reliability of the battery.

As a fortieth aspect of the present disclosure, for example, in the battery according to any one of the twenty-third to thirty-ninth aspects,
the first shaft portion may have a circular cylinder shape, an elliptical cylinder shape, or a polygonal cylinder shape.

This configuration simplifies the structure of the first shaft portion, increasing the productivity.

As a forty-first aspect of the present disclosure, for example, in the battery according to any one of the twenty-third to fortieth aspects,
an outer peripheral side surface of the first shaft portion may have a flat surface parallel to a thickness direction of the power-generation element, on a side opposite to the power-generation element.

Since this configuration enables the electrode terminal portion to be stored more compactly, it increases the energy density of the battery.

As a forty-second aspect of the present disclosure, for example, in the battery according to any one of the twenty-third to forty-first aspects, the separator may be a solid electrolyte layer.

This configuration makes it possible to provide an all-solid-state battery with high energy density.

In the following, embodiments of the present disclosure will be described specifically with reference to the drawings.

All of the following embodiments are for showing general or specific examples.

Numerical values, shapes, materials, constituents, the arrangement positions and methods of connection of constituents, steps, the order of steps, and the like in the following embodiments are examples, and these are not intended to limit the present disclosure. The components in the following embodiments which are not stated in the independent claims are described as being optional components.

Each figure shows a schematic diagram, which is not necessarily illustrated to be precise. Hence, for example, the scale or the like in each figure is not necessarily consistent. In each figure, substantially the same constituents are denoted by the same symbols, and repetitive description is omitted or simplified.

In this specification, the terms indicating the relationship between elements such as “parallel” and “orthogonal” and the terms indicating the shapes of elements such as “rectangle” and “rectangular parallelepiped”, and the ranges of numerical values are not expressions in only a strict sense but expressions that express substantially the same or similar ranges, for example, ranges including differences of several percent or so.

In the present specification and the drawings, the x-axis, the y-axis, and the z-axis correspond to the three axes of a three-dimensional Cartesian coordinate system. In the case in which the shape of a power-generation element of a battery in plan view is rectangular, the x-axis and the y-axis correspond to the directions parallel to a first side and a second side, orthogonal to the first side, of the rectangle. The z-axis corresponds to the laminating direction of a plurality of battery cells included in the power-generation element.

In this specification, the “laminating direction” corresponds to the direction normal to the main surfaces of current collectors and active substance layers. In this specification, “plan view” denotes viewing in the direction perpendicular to the main surfaces of a power-generation element, unless otherwise noted such as in the case in which the term is used alone. In the case in which a phrase “plan view of a certain surface” such as “plan view of a first side surface” is stated, the phrase means a view from the front of the “certain surface”.

In this specification, the terms “upper” and “lower” are not intended to indicate the upward direction (the vertically upward direction) and the downward direction (the vertically downward direction) in the absolute spatial awareness but are used as terms defined by a relative positional relationship based on the laminating order of a laminated structure. The terms “upper” and “lower” are applied to not only the case in which two constituents located away from each other, and another constituent is present between the two constituent, but also the case in which two constituents are in close contact with each other. In the following description, the negative side of the z-axis is defined as “lower” or “on the lower side”, and the positive side of the z-axis is defined as “upper” or “on the upper side”.

In this specification, the ordinal numbers such as “first” and “second” do not denote the number or the order of constituents and are used for the purpose of avoiding confusion between constituents of the same kind and distinguishing between constituents, unless otherwise noted.

### Embodiment 1

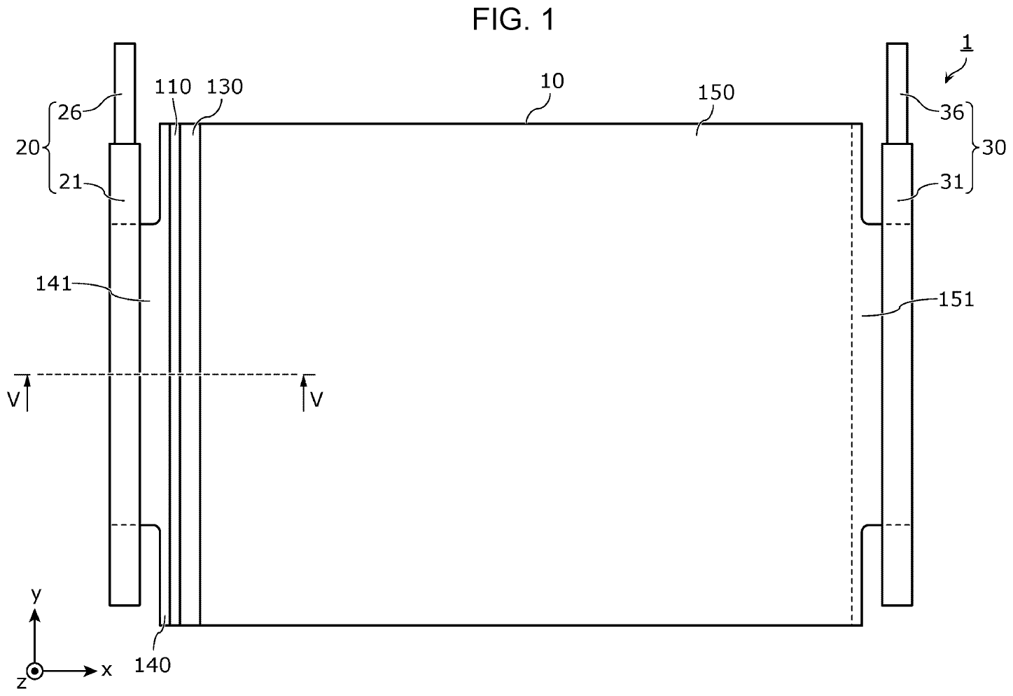

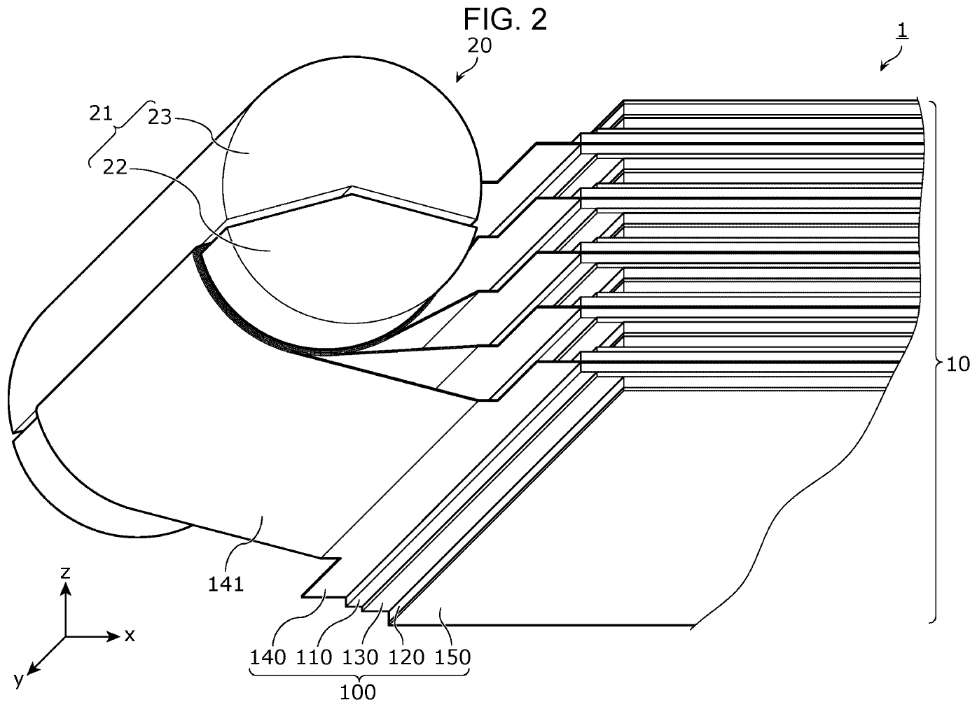

In the following, the configuration of a battery according to Embodiment 1 will be described with reference to FIGS. 1 and 2.

FIG. 1 is a plan view of a battery 1 according to the present embodiment. As illustrated in FIG. 1, the battery 1 includes a power-generation element 10, an electrode core member 20, and a counter-electrode core member 30. The battery 1 is a secondary battery that can be charged and discharged, and is, for example, an all-solid-state battery.

FIG. 2 is an enlarged perspective view of an end portion and its vicinity of the battery 1 according to the present embodiment. Specifically, FIG. 2 is a view of the electrode core member 20 and its vicinity of the battery 1 from an obliquely downward direction.

As illustrated in FIGS. 1 and 2, the power-generation element 10 of the battery 1 includes electrode current collectors 140 each having an electrode terminal portion 141. The electrode terminal portions 141 are wound around an electrode shaft portion 21 of the electrode core member 20. This configuration enables the electrode terminal portions 141 to be stored compactly.

Although not illustrated in FIG. 2, the counter-electrode core member 30 and its vicinity have the same or a similar configuration. Specifically, as illustrated in FIG. 1, the power-generation element 10 includes counter-electrode current collectors 150 each having a counter-electrode terminal portion 151. The counter-electrode terminal portions 151 are wound around a counter-electrode shaft portion 31 of the counter-electrode core member 30. This configuration enables the counter-electrode terminal portions 151 to be stored compactly.

Although details are described later, the electrode terminal portions 141 and the counter-electrode terminal portions 151 are portions that are used for extracting current from the power-generation element 10 and that do not contribute to charging and discharging. Since the electrode terminal portions 141 and the counter-electrode terminal portions 151 are stored compactly, it relatively increases the ratio of the volume of the power-generation element 10 contributing to charging and discharging to the volume of the entire battery 1. This increases the energy density of the battery 1.

The following describes a specific configuration of each constituent included in the battery 1.

### Power-Generation Element

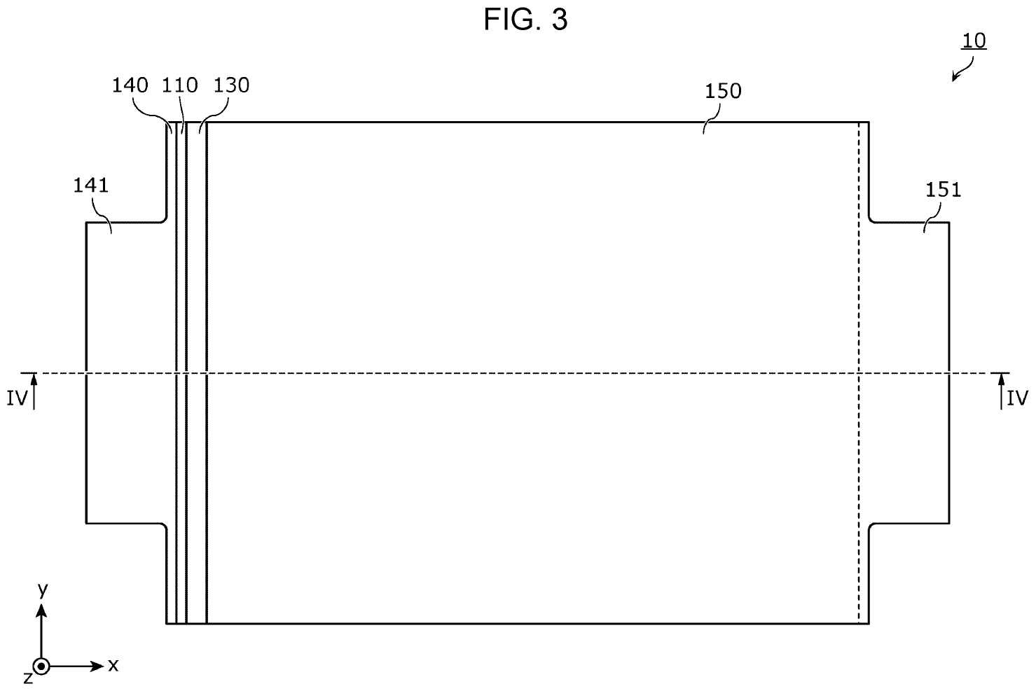

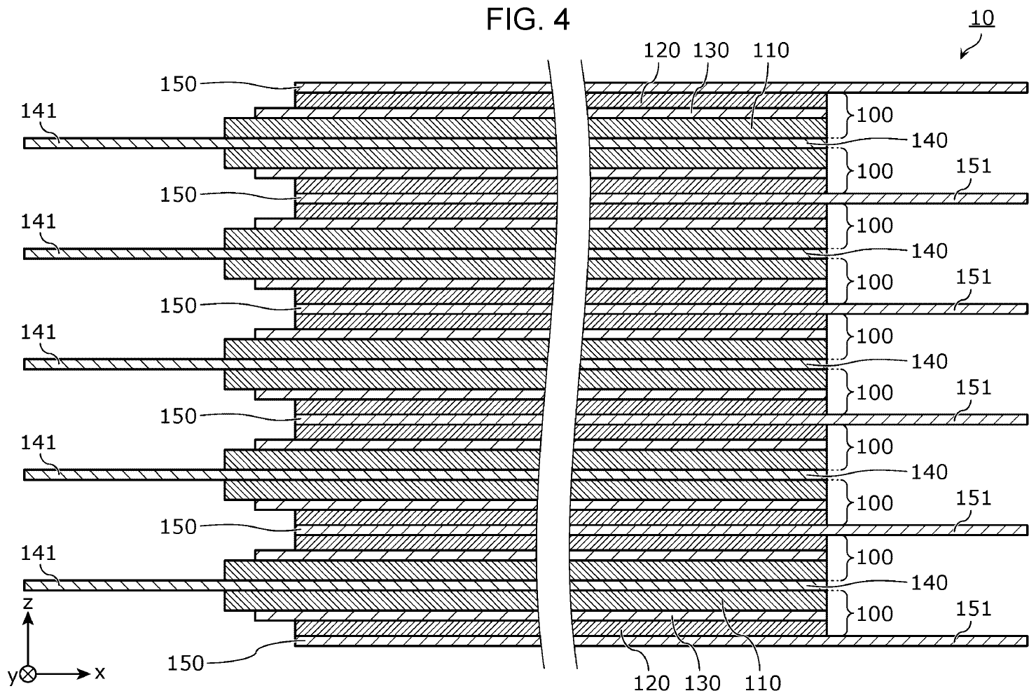

First, a specific configuration of the power-generation element 10 will be described with reference to FIGS. 3 and 4.

FIGS. 3 and 4 are a plan view and a cross-sectional view of the power-generation element 10 of the battery 1 according to the present embodiment before the electrode core member 20 and the counter-electrode core member 30 are attached. FIG. 4 is a cross-sectional view taken along line IV-IV in FIG. 3.

The power-generation element 10 illustrated in FIGS. 3 and 4 is, for example, a power generator having functions of charging and discharging. As illustrated in FIG. 4, the power-generation element 10 includes a plurality of battery cells 100, a plurality of electrode current collectors 140, and a plurality of counter-electrode current collectors 150.

The battery cell 100 is a battery of a smallest configuration and is also referred to as a unit cell. The plurality of battery cells 100 are electrically connected in parallel and laminated. In the example illustrated in FIG. 4, all of the ten battery cells 100 included in the power-generation element 10 are electrically connected in parallel. Note that the number of laminated battery cells 100 is not particularly limited.

With attention focused on two adjacent ones of the plurality of battery cells 100, the laminating order of the layers included in each of the two battery cells is opposite. For example, in the battery cell 100 in the lowermost layer, a counter-electrode layer 120, a solid electrolyte layer 130, and an electrode layer 110 are laminated in this order from bottom to top. In contrast, in the second battery cell 100 from the bottom, an electrode layer 110, a solid electrolyte layer 130, and a counter-electrode layer 120 are laminated in this order from bottom to top. In other words, in these two battery cells 100, the electrode layers 110 of the two battery cells 100 face each other with an electrode current collector 140 located in between. In other words, a counter-electrode layer 120 is located on each main surface of the electrode current collector 140.

In the second and third battery cells 100 from the bottom, the counter-electrode layers 120 of the two battery cells 100 face each other with a counter-electrode current collector 150 located in between. In this configuration, one electrode current collector 140 and one counter-electrode current collector 150 alternate in the z-axis direction.

As described above, the plurality of battery cells 100 are laminated such that the laminating order of the layers is alternately reversed for each battery cell 100. Hence, the laminating order of the layers included in each battery cell 100 is the same for the battery cells 100 of odd numbers and is the same for the battery cells 100 of even numbers. The laminating order of the layers of the odd-numbered battery cells 100 is opposite to the laminating order of the layers of the even-numbered battery cells 100.

In the present embodiment, the electrode layer 110 is, for example, a negative electrode layer, and the counter-electrode layer 120 is, for example, a positive electrode layer. The electrode current collector 140 is, for example, a negative-electrode current collector, and the counter-electrode current collector 150 is, for example, a positive-electrode current collector. Note that the electrode layer 110 may be a positive electrode layer, and the counter-electrode layer 120 may be a negative electrode layer. In that case, the electrode current collector 140 is a positive-electrode current collector, and the counter-electrode current collector 150 is a negative-electrode current collector.

The battery cell 100 is flat and has a flat plate shape. The word “flat” mentioned here denotes that the thickness (in other words, the length in the z-axis direction) is shorter than each side (in other words, the lengths in the x-axis direction and in the y-axis direction) or the maximum width of the main surface. The shape of the battery cell 100 in plan view is not limited to a rectangle and may be another polygon such as a square, a hexagon, or an octagon, or a circular or elliptical shape.

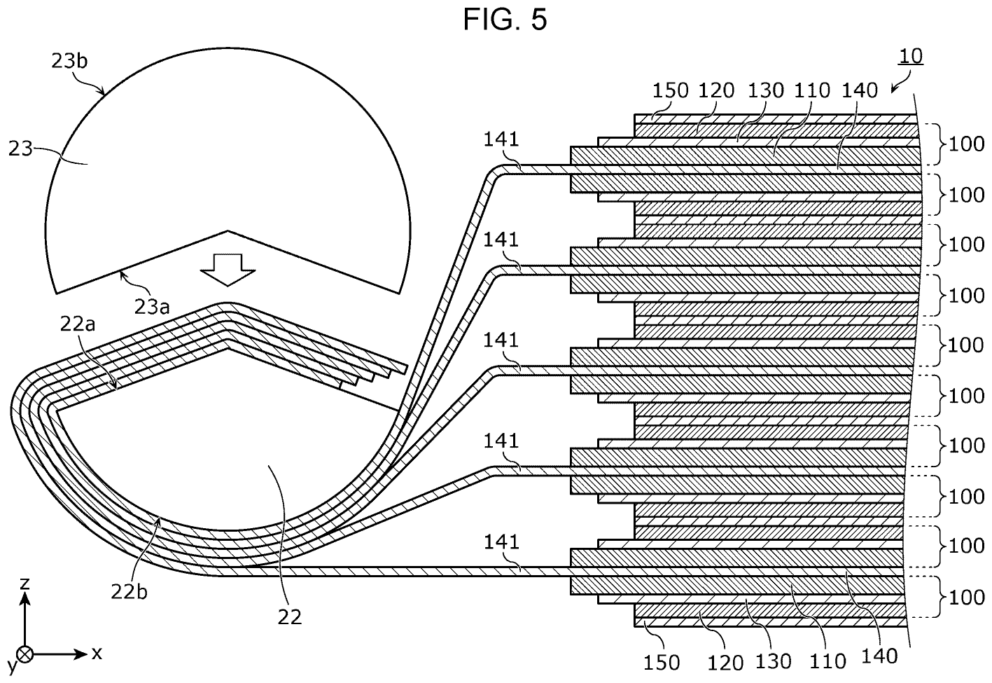

The power-generation element 10 including the plurality of laminated battery cells 100 also has a flat shape. Note that in the illustration in FIG. 4, the thickness of each layer is exaggerated to facilitate understanding of the layer structure of the power-generation element 10. The same applies to FIGS. 2 and 5.

The electrode layer 110 is located between the electrode current collector 140 and the solid electrolyte layer 130. The electrode layer 110 is in contact with a main surface of the electrode current collector 140 and a main surface of the solid electrolyte layer 130.

The electrode layer 110 contains an electrode material. An electrode material is, for example, an active substance. In the present embodiment, the electrode layer 110 is a negative-electrode active substance layer containing a negative-electrode active substance for an electrode material.

For the negative-electrode active substance, various materials that ions of Li, Mg, or the like can be detached from and inserted into are used. Examples of the negative-electrode active substance include graphite and metallic lithium.

The electrode layer 110 may contain, for example, a solid electrolyte such as an inorganic solid electrolyte. For the inorganic solid electrolyte, a sulfide solid electrolyte, an oxide solid electrolyte, or the like is used. Examples of sulfide solid electrolytes include a mixture of Li₂S and P₂S₅.

The electrode layer 110 may contain, for example, a conductive material such as acetylene black, a binder such as polyvinylidene fluoride, and the like. The thickness of the electrode layer 110 is, for example, greater than or equal to 5 μm and less than or equal to 300 μm but is not limited to this range.

The electrode layer 110 can be formed by applying a paint in a paste form in which the constituent material of the electrode layer 110 such as a negative-electrode active substance is kneaded together with a solvent, to one or both of the main surfaces of the electrode current collector 140 and then drying it. To increase the density of the electrode layer 110, the electrode plate including the electrode layer 110 and the electrode current collector 140 may be pressed.

The counter-electrode layer 120 is located between the counter-electrode current collector 150 and the solid electrolyte layer 130. The counter-electrode layer 120 is in contact with a main surface of the counter-electrode current collector 150 and a main surface of the solid electrolyte layer 130.

The counter-electrode layer 120 contains a counter-electrode material. The counter-electrode material is a material forming the counter electrode of the electrode material and is, for example, an active substance. In the present embodiment, the counter-electrode layer 120 is a positive-electrode active substance layer containing a positive-electrode active substance for a counter-electrode material.

For the positive-electrode active substance, various materials that ions of Li, Mg, or the like can be detached from and inserted into are used. Examples of the positive-electrode active substance include lithium cobalt oxide and lithium nickel oxide.

The counter-electrode layer 120 may contain, for example, a solid electrolyte such as an inorganic solid electrolyte. For the inorganic solid electrolyte, a sulfide solid electrolyte, an oxide solid electrolyte, or the like is used. Examples of sulfide solid electrolytes include a mixture of Li₂S and P₂S₅. The surface of the positive-electrode active substance may be coated with a solid electrolyte.

The counter-electrode layer 120 may contain, for example, a conductive material such as acetylene black, a binder such as polyvinylidene fluoride, and the like. The thickness of the counter-electrode layer 120 is, for example, greater than or equal to 5 μm and less than or equal to 300 μm but is not limited to this range.

The counter-electrode layer 120 can be formed by applying a paint in a paste form in which the constituent material of the counter-electrode layer 120 such as a positive-electrode active substance is kneaded together with a solvent, to one or both of the main surfaces of the counter-electrode current collector 150 and then drying it. To increase the density of the counter-electrode layer 120, the counter electrode plate including the counter-electrode layer 120 and the counter-electrode current collector 150 may be pressed.

The solid electrolyte layer 130 is an example of a separator and is located between the electrode layer 110 and the counter-electrode layer 120. The solid electrolyte layer 130 is in contact with a main surface of the electrode layer 110 and a main surface of the counter-electrode layer 120.

The solid electrolyte layer 130 contains a solid electrolyte. Examples of solid electrolytes that are used include an inorganic solid electrolyte. For the inorganic solid electrolyte, a sulfide solid electrolyte, an oxide solid electrolyte, or the like is used. Examples of sulfide solid electrolytes include a mixture of Li₂S and P₂S₅.

The solid electrolyte layer 130 may contain, for example, a binder such as polyvinylidene fluoride, or the like. The thickness of the solid electrolyte layer 130 is, for example, greater than or equal to 5 μm and less than or equal to 100 μm but is not limited to this range.

In the present embodiment, as illustrated in FIGS. 3 and 4, the end surface of the battery cell 100 in the protruding direction of the counter-electrode current collector 150 (on the positive side of the x-axis) is flat. Specifically, the end surface of each of the electrode layer 110, the solid electrolyte layer 130, and the counter-electrode layer 120 on the positive side of the x-axis is flush with one another and forms a flat surface parallel to the z-axis. The end surface of the battery cell 100 on the positive side of the x-axis is flush with the end surface of the electrode current collector 140.

In contrast, the end surface of the battery cell 100 in the protruding direction of the electrode current collector 140 (on the negative side of the x-axis) has a step-like shape. Specifically, on the negative side of the x-axis, the end surfaces of the electrode layer 110, the solid electrolyte layer 130, and the counter-electrode layer 120 are located in this order in the positive direction of the x-axis. On the negative side of the x-axis, the end surface of the counter-electrode layer 120 is flush with the end surface of the counter-electrode current collector 150.

Although not illustrated in FIG. 4, the end surfaces of the battery cells 100 on the positive and negative sides of the y-axis are flat surfaces parallel to the z-axis as with the end surface on the positive side of the x-axis. Specifically, the end surfaces of the power-generation element 10 is flat on the positive and negative sides of the y-axis.

Alternatively, the end surfaces of the battery cells 100 on the positive and negative sides of the y-axis may have step-like shapes as with the end surfaces on the negative side of the x-axis.

With this configuration, the electrode layer 110 which is the negative electrode layer is larger than the counter-electrode layer 120 which is the positive electrode layer in plan view. This configuration makes it possible to avoid the situation in which the negative electrode layer cannot absorb all of the ions transferred from the positive electrode layer to the negative electrode layer, and part of the ions deposit as metal, which becomes a factor of a short circuit. In addition, the difference in dimension enables the distance between the end portions of the electrode layer 110 and the counter-electrode layer 120 to be long. This prevents the occurrence of a short circuit due to crumbling of an end portion or the like.

Note that the negative electrode layer does not necessarily have to be larger than the positive electrode layer. For example, the electrode layer 110 and the counter-electrode layer 120 may have the same size. For example, all of the end surfaces of the battery cells 100 may be flat.

The electrode current collector 140 and the counter-electrode current collector 150 are members having electrical conductivity. The electrode current collector 140 and the counter-electrode current collector 150 are electrically conductive members in the form of a foil, a plate, or a mesh. The electrode current collector 140 and the counter-electrode current collector 150 may be, for example, a thin film having electrical conductivity.

Examples of materials that can be used for the electrode current collector 140 and the counter-electrode current collector 150 include metals such as stainless steel (SUS (a symbol in Japan Industrial Standards)), aluminum (Al), copper (Cu), and nickel (Ni). The electrode current collector 140 and the counter-electrode current collector 150 may be formed of different materials. The thickness of each of the electrode current collector 140 and the counter-electrode current collector 150 is, for example, greater than or equal to 5 μm and less than or equal to 100 μm but is not limited to this range.

The electrode current collector 140 is laminated on the electrode layer 110. In the present embodiment, each electrode current collector 140 is between two electrode layers 110 and is in contact with main surfaces of the two electrode layers 110. The electrode current collector 140 may include a current collector layer provided where the electrode current collector 140 is in contact with the electrode layer 110 and containing a conductive material.

The electrode current collector 140 includes the electrode terminal portion 141 protruding outside the area of the electrode layer 110. The phrase “A protrudes outside the area of B” denotes that part of A is located outside the outer shape of B in plan view, in other words, that A has a portion located outside the area of B and not overlapping B in plan view.

In the present embodiment, the electrode terminal portion 141 protrudes outside the area of the electrode layer 110 in the negative direction of the x-axis. For example, the electrode terminal portions 141 of all the electrode layers 110 protrude in the same direction. As illustrated in FIG. 2, the electrode terminal portions 141 are wound around the electrode shaft portion 21 of the electrode core member 20. A specific configuration will be described later.

As illustrated in FIG. 1, the width of the electrode terminal portion 141 is smaller than the width of the electrode current collector 140. The “width” mentioned here is the length in the direction (specifically, the y-axis direction) orthogonal to the protruding direction of the electrode terminal portion 141. This reduces the possibility that an electrode terminal portion 141 wound around the electrode core member 20 may come into contact with other constituents and cause a short circuit. Note that the width of the electrode terminal portion 141 being smaller than the width of the electrode current collector 140 is not indispensable. For example, the width of the electrode terminal portion 141 may be the same as the width of the electrode current collector 140.

Before the plurality of electrode terminal portions 141 are wound, the length of each electrode terminal portion 141 is the same. Note that the length of the electrode terminal portion 141 refers to that in the protruding direction. In the example of FIG. 4, it is the length along the x-axis. More specifically, the length of the electrode terminal portion 141 is the length from the end surface of the electrode layer 110 on the negative side of the x-axis to the end surface of the electrode terminal portion 141 on the negative side of the x-axis. Note that the lengths of the plurality of electrode terminal portions 141 being the same as one another is not indispensable. The plurality of electrode terminal portions 141 may include electrode terminal portions having different lengths.

The counter-electrode current collector 150 is laminated on the counter-electrode layer 120. In the present embodiment, each counter-electrode current collector 150 is between two counter-electrode layers 120 and is in contact with main surfaces of the two counter-electrode layers 120. The counter-electrode current collector 150 may include a current collector layer provided where the counter-electrode current collector 150 is in contact with the counter-electrode layer 120 and containing a conductive material.

The counter-electrode current collector 150 includes the counter-electrode terminal portion 151 protruding outside the area of the counter-electrode layer 120. In the present embodiment, the protruding direction of the counter-electrode terminal portion 151 differs from the protruding direction of the electrode terminal portion 141. Specifically, as illustrated in FIGS. 3 and 4, the counter-electrode terminal portion 151 protrudes outside the area of the counter-electrode layer 120 in the positive direction of the x-axis. In other words, the electrode terminal portion 141 and the counter-electrode terminal portion 151 protrude in directions opposite to each other.

As schematically illustrated in FIG. 1, the counter-electrode terminal portions 151 are wound around the counter-electrode shaft portion 31 of the counter-electrode core member 30. The concrete configuration is the same as that of the electrode terminal portion 141 and is described later.

As illustrated in FIG. 1, the width of the counter-electrode terminal portion 151 is smaller than the width of the counter-electrode current collector 150. The “width” mentioned here is the length in the direction (specifically, the y-axis direction) orthogonal to the protruding direction of the counter-electrode terminal portion 151. This reduces the possibility that a counter-electrode terminal portion 151 wound around the counter-electrode core member 30 may come into contact with other constituents and causes a short circuit. Note that the width of the counter-electrode terminal portion 151 being smaller than the width of the counter-electrode current collector 150 is not indispensable. For example, the width of the counter-electrode terminal portion 151 may be the same as the width of the counter-electrode current collector 150.

Before the plurality of counter-electrode terminal portions 151 are wound, the length of each counter-electrode terminal portion 151 is the same. Note that the length of the counter-electrode terminal portion 151 refers to that in the protruding direction. In the example of FIG. 4, it is the length along the x-axis. More specifically, the length of the counter-electrode terminal portion 151 is the length from the end surface of the counter-electrode layer 120 on the positive side of the x-axis to the end surface of the counter-electrode terminal portion 151 on the positive side of the x-axis. Note that the lengths of the plurality of counter-electrode terminal portions 151 being the same as one another is not indispensable. The plurality of counter-electrode terminal portions 151 may include counter-electrode terminal portions having different lengths.

### Electrode Core Member and Counter-Electrode Core Member

Next, the electrode core member 20 and the counter-electrode core member 30 will be described. In the present embodiment, the counter-electrode core member 30 has a configuration the same as or similar to that of the electrode core member 20, and hence, the following description focuses on the electrode core member 20.

FIG. 5 is an enlarged cross-sectional view of an end portion and its vicinity of the battery 1 according to the present embodiment. Specifically, FIG. 5 is a cross-sectional view taken along line V-V in FIG. 1. Note that in FIG. 5, hatching with oblique lines for indicating a cross section is omitted in the cross section of the electrode core member 20.

The electrode core member 20 is an example of a first core member. As illustrated in FIG. 1, the electrode core member 20 includes the electrode shaft portion 21 and an electrode outer terminal 26.

The electrode shaft portion 21 is an example of a first conductive portion which is electrically connected to the electrode terminal portions 141. The electrode shaft portion 21 has electrical conductivity. For example, the electrode shaft portion 21 is formed of a metal, conductive carbon, or the like. Metals that can be used for it include various metals such as iron, aluminum, copper, stainless steel, gold, platinum, nickel, and tungsten, and an alloy of metals.

The electrode shaft portion 21 is a rod-shaped member extending in a direction (specifically, in the y-axis direction) orthogonal to the protruding direction of the electrode terminal portions 141. The thickness of the electrode shaft portion 21 is substantially uniform at least in the range in which the electrode terminal portions 141 are wound. The outer peripheral shape of the cross section (xz section) orthogonal to the axial direction of the electrode shaft portion 21 is circular.

As illustrated in FIG. 5, the electrode shaft portion 21 includes a first shaft member 22 and a second shaft member 23. The first shaft member 22 and the second shaft member 23 have shapes formed by axially dividing the electrode shaft portion 21 having a circular cylinder shape. In other words, the electrode shaft portion 21 having a circular cylinder shape is formed by combining the first shaft member 22 and the second shaft member 23.

The first shaft member 22 has a facing surface 22a and an outer surface 22b.

The facing surface 22a is an example of a first surface and extends in the axial direction. The facing surface 22a in the present embodiment includes two surfaces parallel to the axial direction, and the two surfaces are connected to have a common side axially extending and to form a specified angle.

The outer surface 22b is part of the outer surface of the electrode shaft portion 21. The outer surface 22b in the present embodiment is a curved surface, specifically, a shape of a side surface of a circular cylinder.

The second shaft member 23 has a facing surface 23a and an outer surface 23b.

The facing surface 23a is an example of a second surface and extends in the axial direction. The facing surface 23a faces the facing surface 22a. The facing surface 23a includes two surfaces parallel to the axial direction, and the two surfaces are connected to have a common side axially extending and to form a specified angle.

The outer surface 23b is part of the outer surface of the electrode shaft portion 21. The outer surface 23b in the present embodiment is a curved surface, specifically, a shape of a side surface of a circular cylinder. When the first shaft member 22 and the second shaft member 23 are brought closer to each other such that the facing surfaces 22a and 23a come into contact with each other, the outer surface 22b and the outer surface 23b form the side surface of a circular cylinder.

The electrode outer terminal 26 is an example of a first outer connection terminal having electrical conductivity and extends in a specified direction from the electrode shaft portion 21. The electrode outer terminal 26 in the present embodiment is an elongated flat plate axially extending from an axial end portion of the electrode shaft portion 21. The electrode outer terminal 26 is used for electrical connection to another device.

The thickness of the electrode core member 20 is smaller than the thickness of the power-generation element 10. The word “thickness” mentioned here denotes the length of the power-generation element 10 in the laminating direction (specifically, in the z-axis direction). In the present embodiment, the thickness of the electrode shaft portion 21 is smaller than the thickness of the power-generation element 10. For example, in the state in which the plurality of electrode terminal portions 141 are wound around the electrode shaft portion 21, the thickness of the electrode core member 20 including the plurality of electrode terminal portions 141 is smaller than the thickness of the power-generation element 10. This configuration enables the electrode terminal portions 141 to be stored compactly.

The counter-electrode core member 30 is an example of a second core member. As illustrated in FIG. 1, the counter-electrode core member 30 includes the counter-electrode shaft portion 31 and a counter-electrode outer terminal 36.

The counter-electrode shaft portion 31 is an example of a second conductive portion which is electrically connected to the counter-electrode terminal portions 151. The counter-electrode shaft portion 31 has electrical conductivity. For example, the counter-electrode shaft portion 31 is formed of a metal, conductive carbon, or the like. Metals that can be used for it include various metals such as iron, aluminum, copper, stainless steel, gold, platinum, nickel, and tungsten and an alloy of metals.

Although not illustrated, the counter-electrode shaft portion 31 has a configuration the same as or similar to that of the electrode shaft portion 21. Modifications applicable to the electrode shaft portion 21 can also be applied to the counter-electrode shaft portion 31.

The counter-electrode outer terminal 36 is an example of a second outer connection terminal having electrical conductivity and extends in a specified direction from the counter-electrode shaft portion 31. The counter-electrode outer terminal 36 in the present embodiment is an elongated flat plate axially extending from an axial end portion of the counter-electrode shaft portion 31. The counter-electrode outer terminal 36 is used for electrical connection to another device. The extending direction of the counter-electrode outer terminal 36 may differ from the extending direction of the electrode outer terminal 26.

The thickness of the counter-electrode core member 30 is smaller than the thickness of the power-generation element 10. In the present embodiment, the thickness of the counter-electrode shaft portion 31 is smaller than the thickness of the power-generation element 10. For example, in the state in which the plurality of counter-electrode terminal portions 151 are wound around the counter-electrode shaft portion 31, the thickness of the counter-electrode core member 30 including the plurality of counter-electrode terminal portions 151 is smaller than the thickness of the power-generation element 10. This configuration enables the counter-electrode terminal portions 151 to be stored compactly.

### Winding Terminal Portions Around Core Member

Next, how the electrode terminal portions 141 are wound around the electrode core member 20 will be described with reference to FIG. 5. Note that the way of winding the counter-electrode terminal portions 151 around the counter-electrode core member 30 is the same as or similar to the way of winding the electrode terminal portions 141 around the electrode core member 20, and hence, description thereof is omitted.

As illustrated in FIG. 5, the plurality of electrode terminal portions 141 are laminated on top of one another and wound around the electrode core member 20. The term “being wound” denotes that at least part of the plurality of electrode terminal portions 141 are in contact with the outer surface of the electrode core member 20 and are curved, bent, or folded along the outer surface.

For example, the plurality of electrode terminal portions 141 are wound clockwise along the outer surface 22b and the facing surface 22a of the first shaft member 22. The portions of the plurality of electrode terminal portions 141 along the facing surface 22a are held between the facing surface 22a and the facing surface 23a of the second shaft member 23. The one of the plurality of electrode terminal portions 141 located in the uppermost layer comes into contact with the outer surface 22b and the facing surface 22a. The one of the plurality of electrode terminal portions 141 located in the lowermost layer comes into contact with the facing surface 23a.

The electrode terminal portions 141 and the electrode shaft portion 21 may be thermally bonded or welded. Alternatively, the electrode terminal portions 141 and the electrode shaft portion 21 may be bonded with an adhesive conductive material interposed in between. This enables the electrode terminal portions 141 to be electrically connected and physically fixed to the electrode shaft portion 21. Alternatively, by mechanically fixing the first shaft member 22 and the second shaft member 23 to each other, the electrode terminal portions 141 held between the facing surfaces 22a and 23a may be electrically connected and mechanically fixed to the electrode shaft portion 21. Examples of the method of mechanical fixation include screwing and a ring-shaped member described later. The first shaft member 22 and the second shaft member 23 may be fixed together by welding or bonding with an adhesive.

Although the description is based on an example in which the winding direction is clockwise, it may be counterclockwise. In that case, the plurality of electrode terminal portions 141 are wound counterclockwise along the outer surface 23b and the facing surface 23a of the second shaft member 23.

Although FIG. 5 is based on an example in which the plurality of electrode terminal portions 141 are wound around the electrode core member 20 for approximately half a turn, the present disclosure is not limited to this configuration. The plurality of electrode terminal portions 141 may be wound around the outer surface of the electrode core member 20 for one or more turns.

Although the distal ends of the plurality of electrode terminal portions 141 are not at the same position due to the difference in the distance between their winding paths, the present disclosure is not limited to this configuration. For example, the lengths of the plurality of electrode terminal portions 141 may be adjusted in advance so that the distal ends after wound will be at the same position.

As described above, the plurality of electrode terminal portions 141 in the present embodiment are laminated on top of one another and wound around the electrode core member 20. Hence, the lengths of the plurality of electrode terminal portions 141 in the protruding direction after wound can be shorter than the lengths in the protruding direction before wound. In the thickness direction, the sum of the thickness of the electrode shaft portion 21 and the thickness of the plurality of electrode terminal portions 141 after wound is smaller than the thickness of the power-generation element 10. In other words, the plurality of electrode terminal portions 141 do not protrude in the thickness direction. Since the plurality of electrode terminal portions 141 can be stored compactly as described above, it increases the energy density of the battery 1. As compared with cases in which the plurality of electrode terminal portions 141 are wound in a roll without using a core member, this configuration easily stabilizes the smallest diameter at the start of winding. This increases the productivity and also reduces the variation in the size of the wound electrode terminal portions 141. Similarly, also the plurality of counter-electrode terminal portions 151 can be stored compactly, and hence, it further increases the energy density of the battery 1.

### Embodiment 2

Next, Embodiment 2 will be described.

Embodiment 2 differs from Embodiment 1 in that each of the electrode core member and the counter-electrode core member includes a tubular portion. The following description focuses on the differences from Embodiment 1, and description of common points is omitted or simplified.

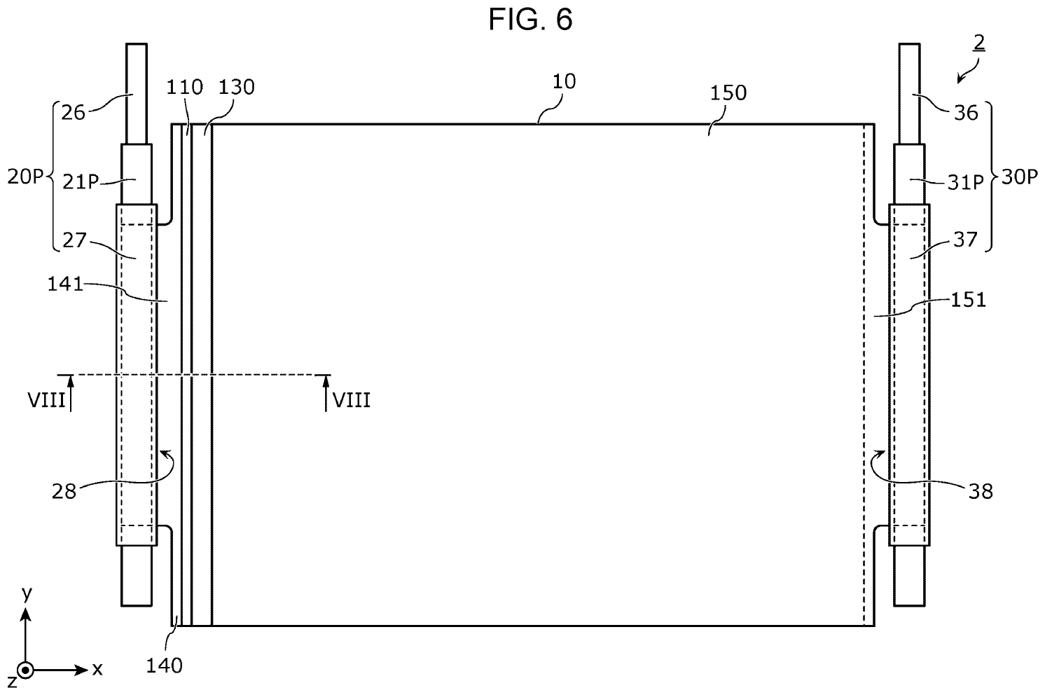

FIG. 6 is a plan view of a battery 2 according to the present embodiment. As illustrated in FIG. 6, the battery 2 includes a power-generation element 10, an electrode core member 20P, and a counter-electrode core member 30P. The battery 2 is a secondary battery that can be charged and discharged and is, for example, an all-solid-state battery.

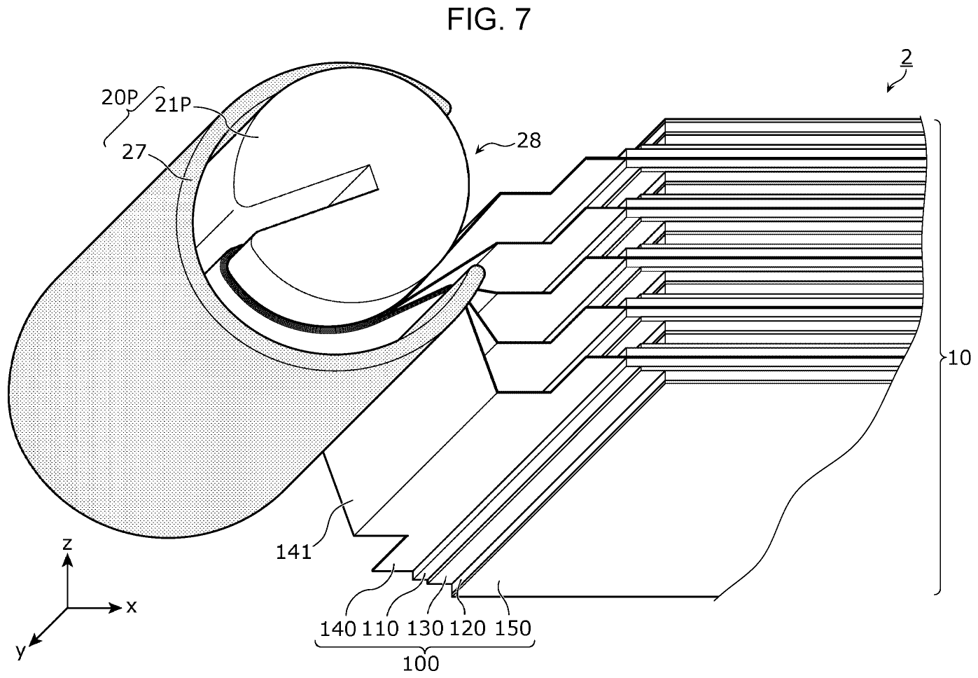

FIG. 7 is an enlarged perspective view of an end portion and its vicinity of the battery 2 according to the present embodiment. Specifically, FIG. 7 is a view of the electrode core member 20P and its vicinity of the battery 2 from an obliquely downward direction.

As illustrated in FIGS. 6 and 7, the power-generation element 10 of the battery 2 includes electrode current collectors 140 each having an electrode terminal portion 141. The electrode terminal portions 141 are wound around an electrode shaft portion 21P of the electrode core member 20P. This configuration enables the electrode terminal portions 141 to be stored compactly. In addition, the electrode terminal portions 141 are covered with an electrode tubular portion 27 of the electrode core member 20P. This configuration enables the electrode terminal portions 141 to be protected, increasing the reliability of the battery 2.

Although not illustrated in FIG. 7, the counter-electrode core member 30P and its vicinity have the same or a similar configuration. Specifically, as illustrated in FIG. 6, the power-generation element 10 includes counter-electrode current collectors 150 each having a counter-electrode terminal portion 151. The counter-electrode terminal portions 151 are wound around a counter-electrode shaft portion 31P of the counter-electrode core member 30P. This configuration enables the counter-electrode terminal portions 151 to be stored compactly. In addition, the counter-electrode terminal portions 151 are covered with a counter-electrode tubular portion 37 of the counter-electrode core member 30P. This configuration enables the counter-electrode terminal portions 151 to be protected, increasing the reliability of the battery 2.

The following describes a specific configuration of each constituent included in the battery 2. Since the power-generation element 10 is the same as the power-generation element 10 of the battery 1 according to Embodiment 1, description thereof is omitted, and the electrode core member 20P and the counter-electrode core member 30P will be described. In the present embodiment, the counter-electrode core member 30P has a configuration the same as or similar to that of the electrode core member 20P, and hence, the following description focuses on the electrode core member 20P.

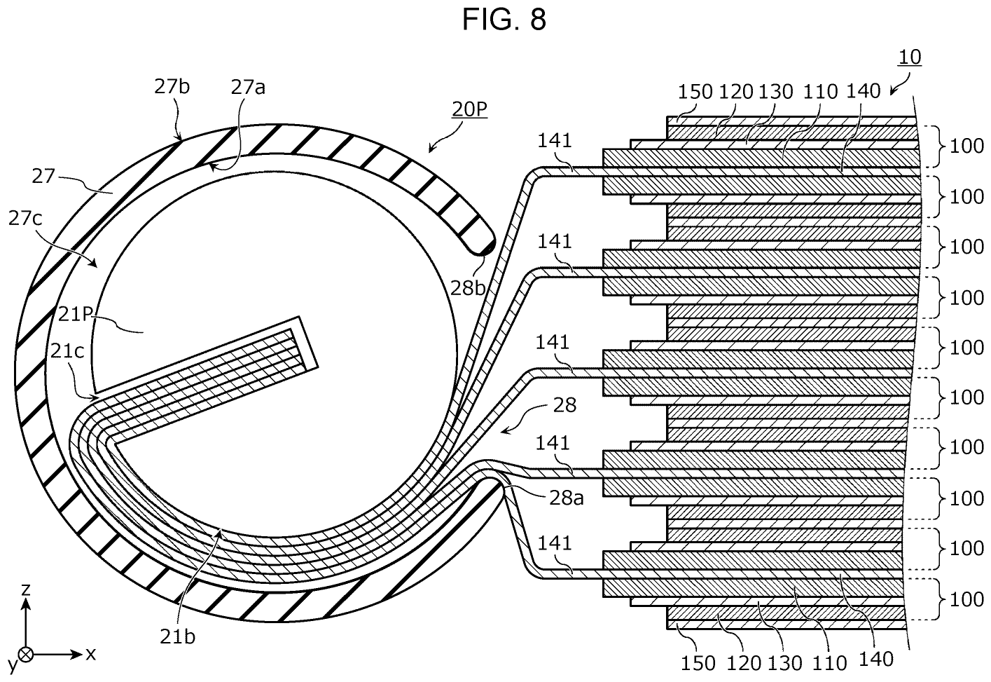

FIG. 8 is an enlarged cross-sectional view of an end portion and its vicinity of the battery 2 according to the present embodiment. Specifically, FIG. 8 is a cross-sectional view taken along line VIII-VIII in FIG. 6. Note that in FIG. 8, hatching with oblique lines for indicating a cross section is omitted in the cross section of the electrode shaft portion 21P of the electrode core member 20P.

The electrode core member 20P is an example of a first core member. As illustrated in FIG. 6, the electrode core member 20P includes the electrode shaft portion 21P, an electrode outer terminal 26, and the electrode tubular portion 27.

The electrode shaft portion 21P is an example of a first shaft portion and is also an example of a first conductive portion which is electrically connected to the electrode terminal portions 141. The electrode shaft portion 21P has electrical conductivity. For example, the electrode shaft portion 21P is formed of a metal, conductive carbon, or the like. Metals that can be used for it include various metals such as iron, aluminum, copper, stainless steel, gold, platinum, nickel, and tungsten and an alloy of metals.

The electrode shaft portion 21P is a rod-shaped member extending in a direction (specifically, in the y-axis direction) orthogonal to the protruding direction of the electrode terminal portions 141. The thickness of the electrode shaft portion 21P is substantially uniform at least in the range in which the electrode terminal portions 141 are wound. The outer peripheral shape of the cross section (xz section) orthogonal to the axial direction of the electrode shaft portion 21P is circular.

As illustrated in FIG. 8, the electrode shaft portion 21P has a groove 21c. The distal ends of the electrode terminal portions 141 are inserted into the groove 21c. The groove 21c is, for example, an elongated groove recessed from the outer surface 21b of the electrode shaft portion 21P toward the center. The groove 21c extends in the axial direction of the electrode shaft portion 21P (in the y-axis direction). The depth of the groove 21c is, for example, greater than the radius of the circle of the cross-sectional shape of the electrode shaft portion 21P, but the present disclosure is not limited to this configuration. In addition, the groove 21c, for example, extends so as to be cut in from one end to the other end of the electrode shaft portion 21P, but the present disclosure is not limited to this configuration. The groove 21c needs only to have a size that the distal ends of the electrode terminal portions 141 can enter and hence is not limited to ones reaching both one end and the other end of the electrode shaft portion 21P.

The electrode outer terminal 26 is an example of a first outer connection terminal having electrical conductivity and extends in a specified direction from the electrode shaft portion 21P. The electrode outer terminal 26 in the present embodiment is an elongated flat plate axially extending from an axial end portion of the electrode shaft portion 21P. The electrode outer terminal 26 is used for electrical connection to another device.

The electrode tubular portion 27 is an example of a first tubular portion in which the electrode shaft portion 21P is located. The electrode tubular portion 27 has an opening 28. The opening 28 is an example of a first opening and extends in the axial direction of the electrode shaft portion 21P. The electrode terminal portions 141 pass through the opening 28 and are wound around the electrode shaft portion 21P.

At least part of the opening 28 is located at a position closer to the power-generation element 10 than the center axis of the electrode shaft portion 21P. For example, at least one of a lower opening end 28a or an upper opening end 28b of the opening 28 is located at a position closer to the power-generation element 10 than the center axis of the electrode shaft portion 21P. In the example illustrated in FIG. 8, the opening 28 faces a side surface of the power-generation element 10. As for the opening 28, the width of the opening 28 (the distance in the z-axis direction) is smaller than the thickness of the electrode shaft portion 21P (the length in the z-axis direction).

The electrode tubular portion 27 is a tubular member having an inner surface 27a, which has a shape conforming to the outer surface 21b of the electrode shaft portion 21P, and an outer surface 27b. In the example illustrated in FIG. 8, the electrode tubular portion 27 has a C-shaped cross section. The inner surface 27a of the electrode tubular portion 27 is one size larger than the outer surface 21b of the electrode shaft portion 21P. In other words, there is a gap 27c between the electrode tubular portion 27 and the electrode shaft portion 21P. As illustrated in FIG. 8, the electrode terminal portions 141 having passed through the opening 28 pass through the gap 27c and are inserted into the groove 21c of the electrode shaft portion 21P. The width of the gap 27c is greater than or equal to the sum of the thicknesses of the plurality of electrode terminal portions 141.

The electrode tubular portion 27 is an electrically conductive member, which is typically formed of a metal, conductive carbon, or the like. Alternatively, the electrode tubular portion 27 may be an insulating member. Metallic materials that can be used for it are not particularly limited, and various materials such as iron, aluminum, copper, stainless steel, gold, platinum, nickel, and tungsten can be used for it.

The thickness of the electrode core member 20P is smaller than the thickness of the power-generation element 10. The word “thickness” mentioned here denotes the length of the power-generation element 10 in the laminating direction (specifically, in the z-axis direction). In the present embodiment, each of the thickness of the electrode shaft portion 21P and the thickness of the electrode tubular portion 27 is smaller than the thickness of the power-generation element 10. For example, in the state in which the plurality of electrode terminal portions 141 are wound around the electrode shaft portion 21P, the thickness of the electrode core member 20P including the plurality of electrode terminal portions 141 is smaller than the thickness of the power-generation element 10. This configuration enables the electrode terminal portions 141 to be stored compactly.

The counter-electrode core member 30P is an example of a second core member. As illustrated in FIG. 6, the counter-electrode core member 30P includes the counter-electrode shaft portion 31P, a counter-electrode outer terminal 36, and the counter-electrode tubular portion 37.

The counter-electrode shaft portion 31P is an example of a second shaft portion and is also an example of a second conductive portion which is electrically connected to the counter-electrode terminal portions 151. The counter-electrode shaft portion 31P has electrical conductivity. For example, the counter-electrode shaft portion 31P is formed of a metal, conductive carbon, or the like. Metals that can be used for it include various metals such as iron, aluminum, copper, stainless steel, gold, platinum, nickel, and tungsten and an alloy of metals.

Although not illustrated, the counter-electrode shaft portion 31P has a configuration the same as or similar to that of the electrode shaft portion 21P. Modifications applicable to the electrode shaft portion 21P can also be applied to the counter-electrode shaft portion 31P.

The counter-electrode outer terminal 36 is an example of a second outer connection terminal having electrical conductivity and extends in a specified direction from the counter-electrode shaft portion 31P. The counter-electrode outer terminal 36 in the present embodiment is an elongated flat plate axially extending from an axial end portion of the counter-electrode shaft portion 31P. The counter-electrode outer terminal 36 is used for electrical connection to another device. The extending direction of the counter-electrode outer terminal 36 may differ from the extending direction of the electrode outer terminal 26.

The counter-electrode tubular portion 37 is an example of a second tubular portion in which the counter-electrode shaft portion 31P is located. As illustrated in FIG. 6, the counter-electrode tubular portion 37 has an opening 38. The opening 38 is an example of a second opening and extends in the axial direction of the counter-electrode shaft portion 31P. The counter-electrode terminal portions 151 pass through the opening 38 and are wound around the counter-electrode shaft portion 31P. The counter-electrode tubular portion 37 has the same shape as the electrode tubular portion 27.

The thickness of the counter-electrode core member 30P is smaller than the thickness of the power-generation element 10. In the present embodiment, each of the thickness of the counter-electrode shaft portion 31P and the thickness of the counter-electrode tubular portion 37 is smaller than the thickness of the power-generation element 10. For example, in the state in which the plurality of counter-electrode terminal portions 151 are wound around the counter-electrode shaft portion 31P, the thickness of the counter-electrode core member 30P including the plurality of counter-electrode terminal portions 151 is smaller than the thickness of the power-generation element 10. This configuration enables the counter-electrode terminal portions 151 to be stored compactly.

### Winding Terminal Portions Around Core Member

Next, how the electrode terminal portions 141 are wound around the electrode core member 20P will be described with reference to FIG. 8. Note that the way of winding the counter-electrode terminal portions 151 around the counter-electrode core member 30P is the same as or similar to the way of winding the electrode terminal portions 141 around the electrode core member 20P, and hence, description thereof is omitted.

As illustrated in FIG. 8, the plurality of electrode terminal portions 141 laminated on top of one another pass through the opening 28 and are wound around the electrode shaft portion 21P. The term “being wound” denotes that at least part of the plurality of electrode terminal portions 141 are in contact with the outer surface of the electrode shaft portion 21P and are curved, bent, or folded along the outer surface.

For example, the plurality of electrode terminal portions 141 pass through the opening 28 of the electrode tubular portion 27 and are wound clockwise along the outer surface 21b of the electrode shaft portion 21P, and the distal end portions of the plurality of electrode terminal portions 141 are inserted into the groove 21c of the electrode shaft portion 21P. As described above, in the present embodiment, the paths of the plurality of electrode terminal portions 141 are restricted so as to pass through the opening 28. Where the plurality of electrode terminal portions 141 pass through the opening 28, at least one of the plurality of electrode terminal portions 141 comes into contact with the opening end 28a of the opening 28.

In the example illustrated in FIG. 8, the electrode terminal portion 141 in the lowermost layer is in contact with the opening end 28a. The electrode terminal portion 141 in the lowermost layer, to pass through the opening 28, takes a detour instead of taking the shortest path and is then wound around the electrode shaft portion 21P. This configuration reduces the difference in the winding path length between the plurality of electrode terminal portions 141. Note that the difference in the path length can occur due to the thickness of the power-generation element 10 and the circumference of the electrode shaft portion 21P.

In the present embodiment, the difference in the path length is reduced even if the lengths of the plurality of electrode terminal portions 141 are the same. Hence, when the electrode terminal portions 141 are wound around the electrode shaft portion 21P, it is possible to make the distal end portions of the electrode terminal portions 141 located at the same position or to reduce the positional differences of the distal end portions. This configuration increases the reliability of connection between the electrode terminal portions 141 and the electrode shaft portion 21P. As described above, the lengths of the plurality of electrode terminal portions 141 can be the same, which makes it easy to form the plurality of electrode terminal portions 141 and increases the productivity.

The electrode tubular portion 27 is attached, after the plurality of electrode terminal portions 141 are wound around the electrode shaft portion 21P, by being slid in the axial direction of the electrode shaft portion 21P such that the plurality of electrode terminal portions 141 pass through the opening 28. Alternatively, the electrode tubular portion 27 is elasticity deformed so that the opening 28 opens widely, and then, the electrode tubular portion 27 may be attached to the electrode shaft portion 21P so as to hold the plurality of electrode terminal portions 141 wound around the electrode shaft portion 21P in the up-down direction. After the attachment, a force may be applied to the electrode tubular portion 27 in the up-down direction to reduce the width of the opening 28. The method of attaching the electrode tubular portion 27 is not limited to the examples mentioned above. In addition, the path lengths of the plurality of electrode terminal portions 141 can be adjusted by rotating the attached electrode tubular portion 27 around the electrode shaft portion 21P.

The electrode terminal portions 141 and the electrode shaft portion 21P may be thermally bonded or welded. Alternatively, the electrode terminal portions 141 and the electrode shaft portion 21P may be bonded with an adhesive conductive material interposed in between. This enables the electrode terminal portions 141 to be electrically connected and physically fixed to the electrode shaft portion 21P.

Although the description is based on an example in which the winding direction is clockwise, it may be counterclockwise.

Although FIG. 8 is based on an example in which the plurality of electrode terminal portions 141 are wound around the electrode shaft portion 21P for approximately half a turn, the present disclosure is not limited to this configuration. The plurality of electrode terminal portions 141 may be wound around the outer surface of the electrode shaft portion 21P for one or more turns.

As described above, in the present embodiment, the plurality of electrode terminal portions 141 are laminated on top of one another and wound around the electrode core member 20P. Hence, the lengths of the plurality of electrode terminal portions 141 in the protruding direction after wound can be shorter than the lengths in the protruding direction before wound. In the thickness direction, the sum of the thickness of the electrode shaft portion 21P and the thickness of the plurality of electrode terminal portions 141 after wound is smaller than the thickness of the power-generation element 10. In other words, the plurality of electrode terminal portions 141 do not protrude in the thickness direction. Since the plurality of electrode terminal portions 141 can be stored compactly as described above, it increases the energy density of the battery 2. Since the difference in the path length between the plurality of electrode terminal portions 141 is small, it is possible to wind the plurality of electrode terminal portions 141 around the electrode shaft portion 21P easily and firmly. This increases the reliability of the battery 2. As compared with cases in which the plurality of electrode terminal portions 141 are wound in a roll without using a core member, this configuration easily stabilizes the smallest diameter at the start of winding. This increases the productivity and also reduces the variation in the size of the wound electrode terminal portions 141. Similarly, also the plurality of counter-electrode terminal portions 151 can be stored compactly, and hence, it further increases the energy density and the reliability of the battery 2.

### Modification Examples of Embodiments 1 and 2

Next, modification examples of Embodiments 1 and 2 will be described. The modification examples described below are also applicable to Embodiment 3 described later, its modification examples, and the like.

### Modification Examples of Shaft Portion of Core Member

Next, modification examples of the electrode shaft portions 21 and 21P will be described. The modification examples of the electrode shaft portions 21 and 21P described below are also applicable to the counter-electrode shaft portions 31 and 31P. The following description focuses on the differences from the electrode shaft portions 21 and 21P according to the aforementioned embodiments, and description of common points is omitted or simplified.

### Modification Example 1

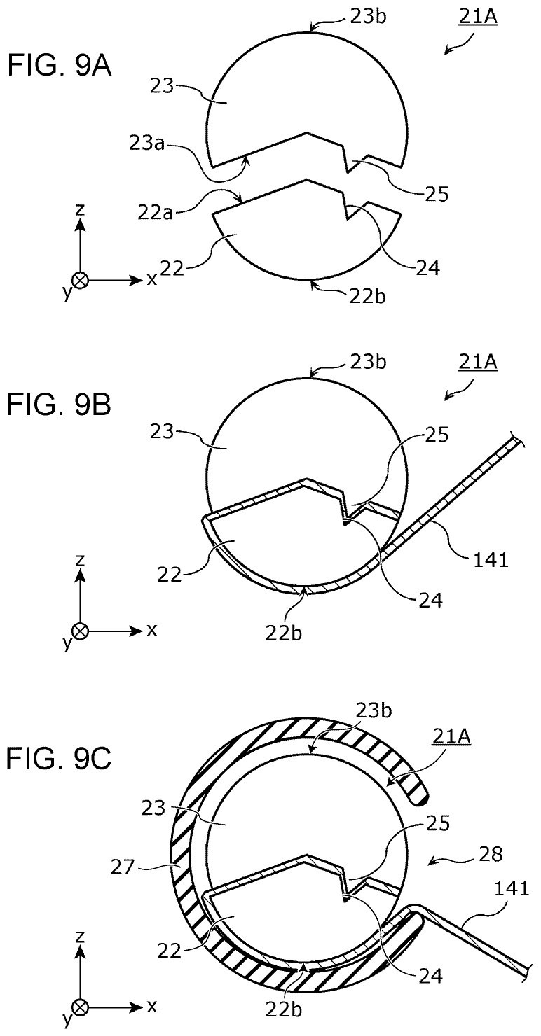

FIG. 9A is a cross-sectional view of an electrode shaft portion 21A according to Modification Example 1. FIG. 9B is a cross-sectional view of the electrode shaft portion 21A according to Modification Example 1 and wound electrode terminal portions 141. FIG. 9C is a cross-sectional view of the electrode shaft portion 21A and an electrode tubular portion 27 according to Modification Example 1 and the wound electrode terminal portions 141. As in FIGS. 5 and 8, hatching with oblique lines for indicating the cross section of the electrode shaft portion 21A is omitted. In FIGS. 9B and 9C, only one electrode terminal portion 141 is depicted to avoid complication of the figures. FIGS. 9B and 9C are based on the assumption that the power-generation element 10 is located on the positive side of the x-axis as in FIGS. 5 and 8. The same applies to the figures of the modification examples described later.

As illustrated in FIG. 9A, in the electrode shaft portion 21A according to the present modification example, the facing surface 22a has a recess 24, and the facing surface 23a has a protrusion 25. The recess 24 is an example of a first recess. The protrusion 25 is an example of a second protrusion and is fitted into the recess 24. The recess 24 and the protrusion 25 each have an elongated triangular prism shape extending in the axial direction of the electrode shaft portion 21A, but the present disclosure is not limited to this configuration. The recess 24 and the protrusion 25 may have another polygonal prism shape such as a square prism or may have a semi-cylindrical prism shape. Alternatively, the recess 24 and the protrusion 25 are not limited to ones extending in the axial direction of the electrode shaft portion 21A. For example, they may have a pyramidal shape such as a triangular or quadrangular pyramid or a hemispherical shape. The electrode shaft portion 21A may have a plurality of recesses 24 and a plurality of protrusions 25.

As illustrated in FIG. 9B, when the electrode terminal portions 141 are held between the recess 24 and the protrusion 25, bent portions are formed near the distal ends of the electrode terminal portions 141. Alternatively, as illustrated in FIG. 9C, the first shaft member 22 and the second shaft member 23 may be combined with the distal end portions of the electrode terminal portions 141 held in between and be stored in the electrode tubular portion 27. With this configuration, the electrode terminal portions 141 are likely to be caught by the electrode shaft portion 21A, making it less likely for the electrode terminal portions 141 to be pulled off. This increases the reliability of the electrical connection and physical fixation between the electrode terminal portions 141 and the electrode shaft portion 21A, increasing the reliability of the battery 1 or 2. The present modification example also enables the electrode terminal portions 141 to be stored compactly as with other modification examples, increasing the energy density of the battery 1 or 2.

Note that the facing surface 22a may have a protrusion 25 as an example of a first protrusion, and the facing surface 23a may have a recess 24 as an example of a second recess. Alternatively, each of the facing surfaces 22a and 23a may have a recess and a protrusion so that the recess and the protrusion of the facing surface 22a can fit with the protrusion of and the recess of the facing surface 23a.

### Modification Example 2

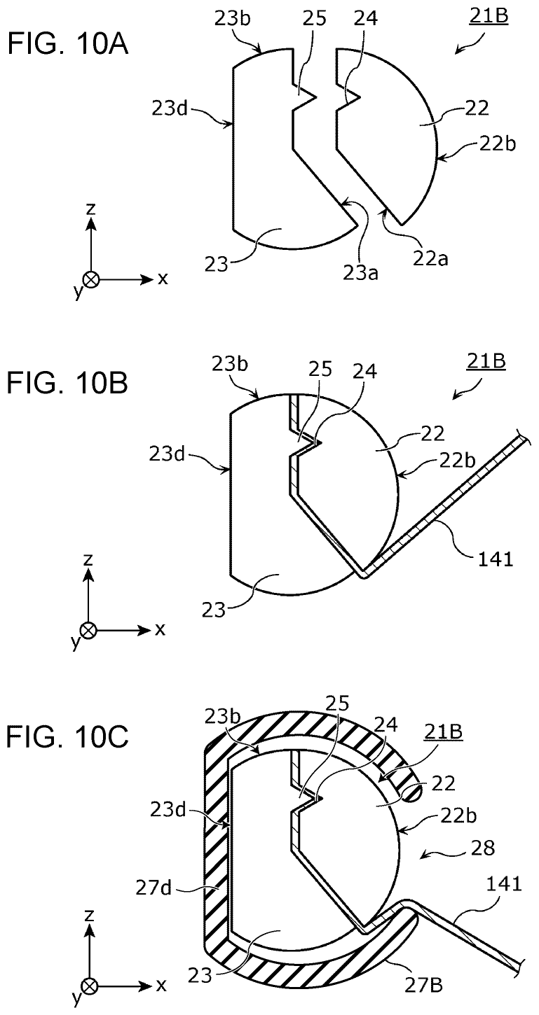

FIG. 10A is a cross-sectional view of an electrode shaft portion 21B according to Modification Example 2. FIG. 10B is a cross-sectional view of the electrode shaft portion 21B according to Modification Example 2 and wound electrode terminal portions 141. FIG. 10C is a cross-sectional view of the electrode shaft portion 21B and an electrode tubular portion 27B according to Modification Example 2 and the wound electrode terminal portions 141.

As illustrated in FIG. 10A, the electrode shaft portion 21B according to the present modification example has a flat surface 23d on its outer surface. The flat surface 23d is parallel to the thickness direction of the power-generation element 10 and is located on the side opposite to the power-generation element 10.

In the electrode shaft portion 21B, the inclination angles of the facing surfaces 22a and 23a differ from those of the electrode shaft portion 21A. Hence, as illustrated in FIGS. 10B and 10C, the electrode terminal portions 141 are in contact with only a portion of the outer surface 22b. As mentioned above, a configuration in which the portion of the outer surface 22b with which the electrode terminal portions 141 are in contact is small is possible.

As illustrated in FIG. 10C, the electrode tubular portion 27B has a flat portion 27d conforming to the flat surface 23d. The flat portion 27d is parallel to the thickness direction of the power-generation element 10 and is located on the side opposite to the power-generation element 10.

In the example illustrated in FIG. 10B, forming the flat surface 23d makes the electrode shaft portion 21B smaller. Specifically, since the portion of the electrode shaft portion 21B farthest from the power-generation element 10 is closer to the power-generation element 10, the overall size of the battery 1 can be smaller. Since the volume of the portions of the battery 1 not contributing charging and discharging can be smaller, it further increases the energy density of the battery 1.

In the example illustrated in FIG. 10C, forming the flat surface 23d and the flat portion 27d makes the electrode shaft portion 21B and the electrode tubular portion 27B smaller. Specifically, since the portion of the electrode tubular portion 27B farthest from the power-generation element 10 is closer to the power-generation element 10, the overall size of the battery 2 can be smaller. Since the volume of the portions of the battery 2 not contributing charging and discharging can be smaller, it further increases the energy density of the battery 2.

Note that the flat surface 23d is not limited to ones parallel to the thickness direction of the power-generation element 10 and may be inclined relative to the thickness direction. The flat portion 27d is also not limited to ones parallel to the thickness direction of the power-generation element 10 and may be inclined relative to the thickness direction.

### Modification Example 3

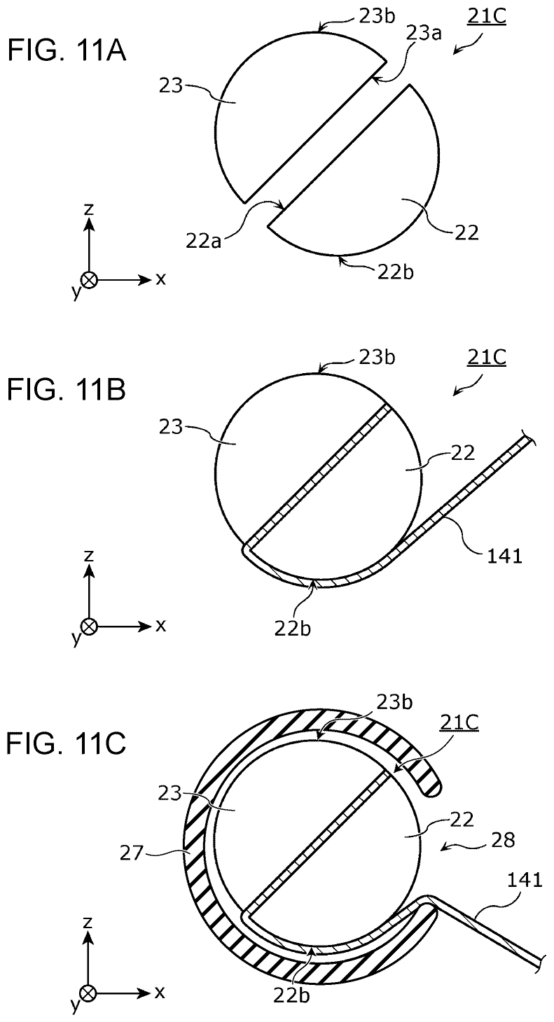

FIG. 11A is a cross-sectional view of an electrode shaft portion 21C according to Modification Example 3. FIG. 11B is a cross-sectional view of the electrode shaft portion 21C according to Modification Example 3 and wound electrode terminal portions 141. FIG. 11C is a cross-sectional view of the electrode shaft portion 21C and an electrode tubular portion 27 according to Modification Example 3 and the wound electrode terminal portions 141.

As illustrated in FIG. 11A, in the electrode shaft portion 21C according to the present modification example, each of the facing surfaces 22a and 23a is one flat surface. As illustrated in FIGS. 11B and 11C, the electrode terminal portions 141 are held between the flat facing surfaces 22a and 23a.

Also the present modification example enables the electrode terminal portions 141 to be stored compactly as with other modification examples, increasing the energy density of the battery 1 or 2. Since the electrode shaft portion 21C has a simple structure, which increases the productivity of the battery 1 or 2.

### Modification Example 4

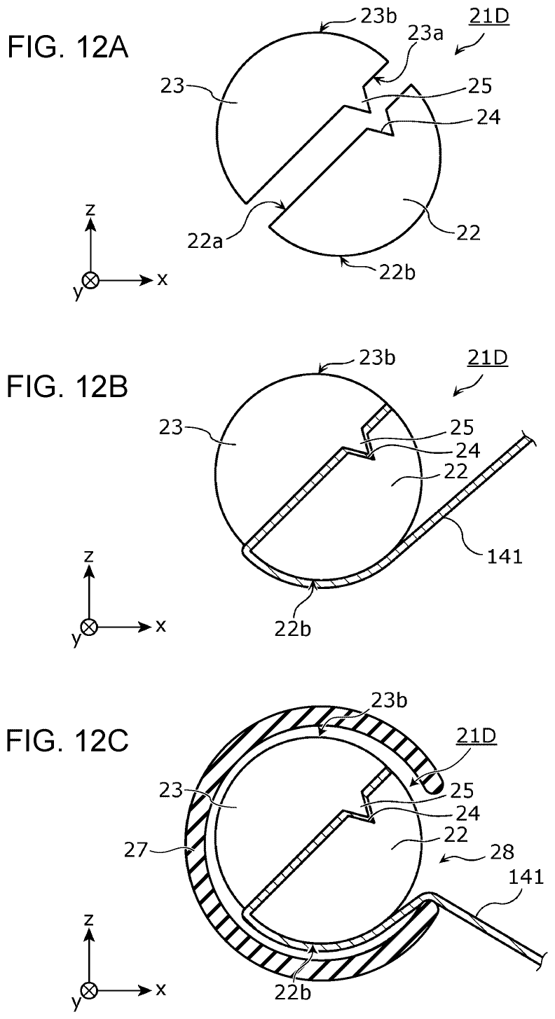

FIG. 12A is a cross-sectional view of an electrode shaft portion 21D according to Modification Example 4. FIG. 12B is a cross-sectional view of the electrode shaft portion 21D according to Modification Example 4 and wound electrode terminal portions 141. FIG. 12C is a cross-sectional view of the electrode shaft portion 21D and an electrode tubular portion 27 according to Modification Example 4 and the wound electrode terminal portions 141.

As illustrated in FIG. 12A, in the electrode shaft portion 21D, the facing surface 22a has a recess 24, and the facing surface 23a has a protrusion 25 as in the electrode shaft portion 21A according to Modification Example 1. As illustrated in FIGS. 12B and 12C, when the electrode terminal portions 141 are held between the recess 24 and the protrusion 25, bent portions are formed near the distal ends of the electrode terminal portions 141.

As in Modification Example 1, this increases the reliability of the electrical connection and physical fixation between the electrode terminal portions 141 and the electrode shaft portion 21D, increasing the reliability of the battery 1 or 2. In addition, since the electrode terminal portions 141 can be stored compactly, it increases the energy density of the battery 1 or 2.

### Modification Example 5

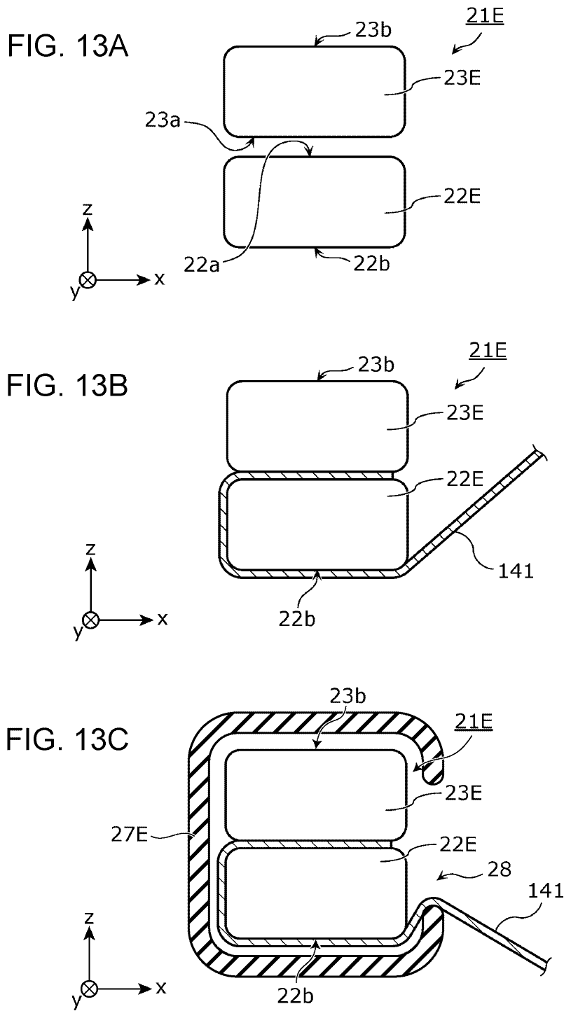

FIG. 13A is a cross-sectional view of an electrode shaft portion 21E according to Modification Example 5. FIG. 13B is a cross-sectional view of the electrode shaft portion 21E according to Modification Example 5 and wound electrode terminal portions 141. FIG. 13C is a cross-sectional view of the electrode shaft portion 21E and an electrode tubular portion 27E according to Modification Example 5 and the wound electrode terminal portions 141.

As illustrated in FIG. 13A, the shape of the electrode shaft portion 21E according to the present modification example is a rectangular prism extending in the axial direction. Specifically, the electrode shaft portion 21E includes a first shaft member 22E and a second shaft member 23E. Each of the first shaft member 22E and the second shaft member 23E has a rectangular prism shape. The corner portions of the first shaft member 22E and the second shaft member 23E are rounded. As illustrated in FIG. 13B, this allows wound electrode terminal portions 141 not to be bent at a right angle. This prevents the electrode terminal portions 141 from receiving a strong force, preventing breakage of the electrode terminal portions 141.

As illustrated in FIG. 13C, the electrode tubular portion 27E according to the present modification example is a tubular member having a shape conforming to the outer surface of the electrode shaft portion 21E having a rectangular prism shape. Specifically, the electrode tubular portion 27E has a cross section having a rectangular outline a part of which is open. The first shaft member 22E and the second shaft member 23E are combined with the distal end portions of the electrode terminal portions 141 held in between and are stored in the electrode tubular portion 27E.

The corner portions of the first shaft member 22E and the second shaft member 23E are rounded. As illustrated in FIG. 13C, this allows wound electrode terminal portions 141 not to be bent at a right angle. This prevents the electrode terminal portions 141 from receiving a strong force, preventing breakage of the electrode terminal portions 141.

Since the present modification example enables the electrode terminal portions 141 to be stored compactly, it increases the energy density of the battery 1 or 2.

Note that the first shaft member 22E and the second shaft member 23E may be plate-shaped. This configuration reduces the total thickness of the electrode shaft portion 21E, reduces the volume of the electrode shaft portion 21E, and makes it possible to increase the battery capacitance.

### Modification Example 6

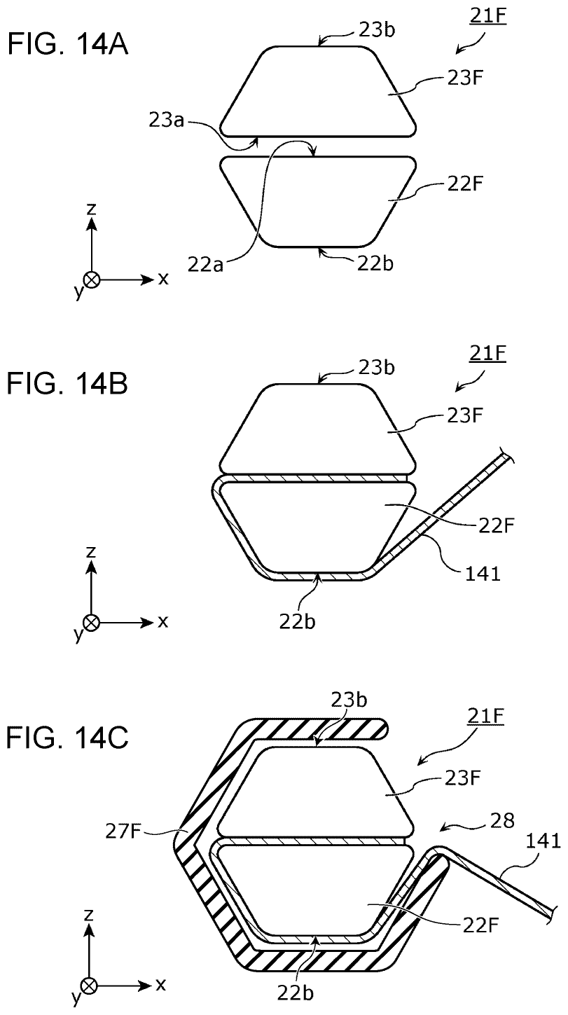

FIG. 14A is a cross-sectional view of an electrode shaft portion 21F according to Modification Example 6. FIG. 14B is a cross-sectional view of the electrode shaft portion 21F according to Modification Example 6 and wound electrode terminal portions 141. FIG. 14C is a cross-sectional view of the electrode shaft portion 21F and an electrode tubular portion 27F according to Modification Example 6 and the wound electrode terminal portions 141.

As illustrated in FIG. 14A, the shape of the electrode shaft portion 21F according to the present modification example is a hexagonal prism extending in the axial direction. Specifically, the electrode shaft portion 21F includes a first shaft member 22F and a second shaft member 23F. Each of the first shaft member 22F and the second shaft member 23F is a quadrilateral prism shape with an isosceles trapezoid base. The corner portions of the first shaft member 22F and the second shaft member 23F are rounded. As illustrated in FIG. 14B, this allows wound electrode terminal portions 141 not to be bent at a right angle. This prevents the electrode terminal portions 141 from receiving a strong force, preventing breakage of the electrode terminal portions 141.

As illustrated in FIG. 14C, the electrode tubular portion 27F according to the present modification example is a tubular member having a shape conforming to the outer surface of the electrode shaft portion 21F having a hexagonal prism shape. Specifically, the electrode tubular portion 27F has a cross section having a hexagonal outline a part of which is open. The first shaft member 22F and the second shaft member 23F are combined with the distal end portions of the electrode terminal portions 141 held in between and are stored in the electrode tubular portion 27F.

Since the present modification example enables the electrode terminal portions 141 to be stored compactly, it increases the energy density of the battery 1 or 2.

Note that the shapes of the first shaft member 22F and the second shaft member 23F are not limited to a quadrilateral prism and may be a triangular prism or another polygonal prism. In other words, also the shape of the electrode shaft portion 21F formed by combining the first shaft member 22F and the second shaft member 23F is not limited to a hexagonal prism and may be another polygonal prism. In addition, the shapes of the first shaft member 22F and the second shaft member 23F may be different.

Similarly, the shape of the electrode tubular portion 27F is not limited to ones conforming to the outer surface of the electrode shaft portion 21F. For example, an electrode tubular portion 27 having a C-shaped cross section may be substituted for the electrode tubular portion 27F.

### Modification Example 7

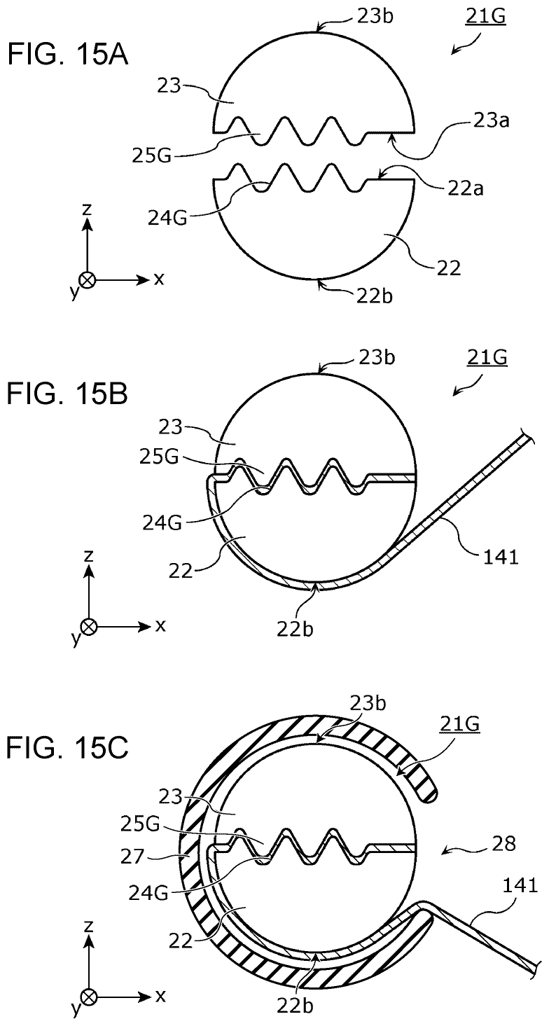

FIG. 15A is a cross-sectional view of an electrode shaft portion 21G according to Modification Example 7. FIG. 15B is a cross-sectional view of the electrode shaft portion 21G according to Modification Example 7 and wound electrode terminal portions 141. FIG. 15C is a cross-sectional view of the electrode shaft portion 21G and an electrode tubular portion 27 according to Modification Example 7 and the wound electrode terminal portions 141.

As illustrated in FIG. 15A, in the electrode shaft portion 21G according to the present modification example, the facing surface 22a has a plurality of recesses 24G, and the facing surface 23a has a plurality of protrusions 25G. The shape of each recess 24G and the shape of each protrusion 25G are, for example, the same as those of the recess 24 and the protrusion 25 according to Modification Example 1. Each of the recesses 24G and each of the protrusions 25G are formed to fit with each other. As illustrated in FIG. 15B, when the electrode terminal portions 141 are held between the plurality of recesses 24G and the plurality of protrusions 25G, bent portions are formed near the distal ends of the electrode terminal portions 141.

Alternatively, as illustrated in FIG. 15C, the electrode terminal portions 141 pass through an opening 28 of the electrode tubular portion 27 and are wound around the electrode shaft portion 21G, and the distal end portions of the electrode terminal portions 141 are held between the plurality of recesses 24G and the plurality of protrusions 25G. This forms bent portions near the distal ends of the electrode terminal portions 141.

This further increases the reliability of the electrical connection and physical fixation between the electrode terminal portions 141 and the electrode shaft portion 21G, further increasing the reliability of the battery 1 or 2. In addition, since the electrode terminal portions 141 can be stored compactly, it increases the energy density of the battery 1 or 2.

### Modification Example 8

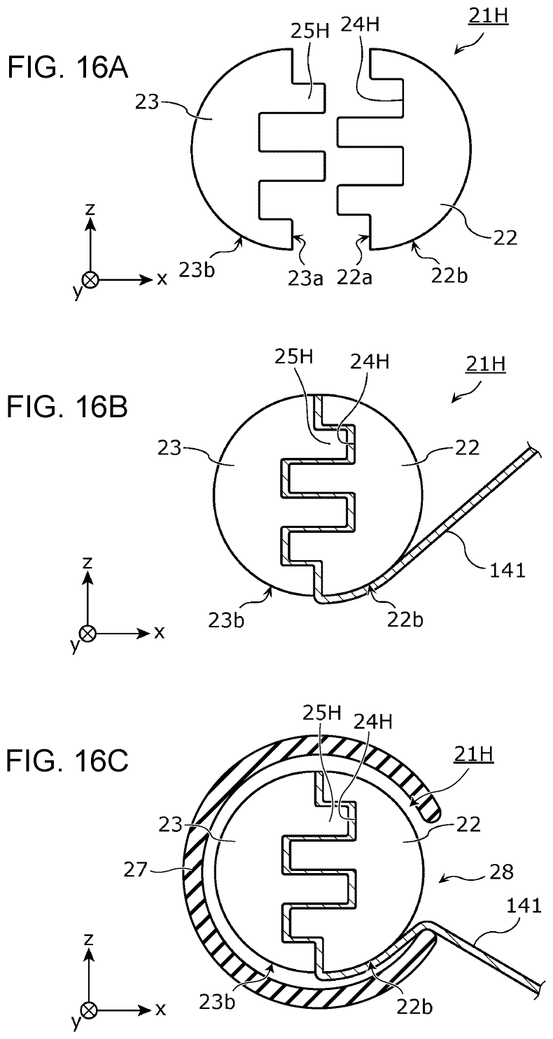

FIG. 16A is a cross-sectional view of an electrode shaft portion 21H according to Modification Example 8. FIG. 16B is a cross-sectional view of the electrode shaft portion 21H according to Modification Example 8 and wound electrode terminal portions 141. FIG. 16C is a cross-sectional view of the electrode shaft portion 21H and an electrode tubular portion 27 according to Modification Example 8 and the wound electrode terminal portions 141.

As illustrated in FIG. 16A, in the electrode shaft portion 21H according to the present modification example, the facing surface 22a has a plurality of recesses 24H, and the facing surface 23a has a plurality of protrusions 25H. The shape of each recess 24H and the shape of each protrusion 25H are, for example, a rectangular prism extending in the axial direction. Each of the recesses 24H and each of the protrusions 25H are formed to fit with each other. As illustrated in FIG. 16B, when the electrode terminal portions 141 are held between the plurality of recesses 24H and the plurality of protrusions 25H, bent portions are formed near the distal ends of the electrode terminal portions 141.

Alternatively, as illustrated in FIG. 16C, the electrode terminal portions 141 pass through an opening 28 of the electrode tubular portion 27 and are wound around the electrode shaft portion 21H, and the distal end portions of the electrode terminal portions 141 are held between the plurality of recesses 24H and the plurality of protrusions 25H. This forms bent portions near the distal ends of the electrode terminal portions 141.

This further increases the reliability of the electrical connection and physical fixation between the electrode terminal portions 141 and the electrode shaft portion 21H, further increasing the reliability of the battery 1 or 2. As compared with the recess 24 or the protrusion 25 with triangular prism shapes, this configuration makes the lengths of the bent portions of the electrode terminal portions 141 long, which enables the electrode terminal portions 141 to be stored more compactly. Thus, it is possible to further increase the energy density of the battery 1 or 2.

### Modification Example 9

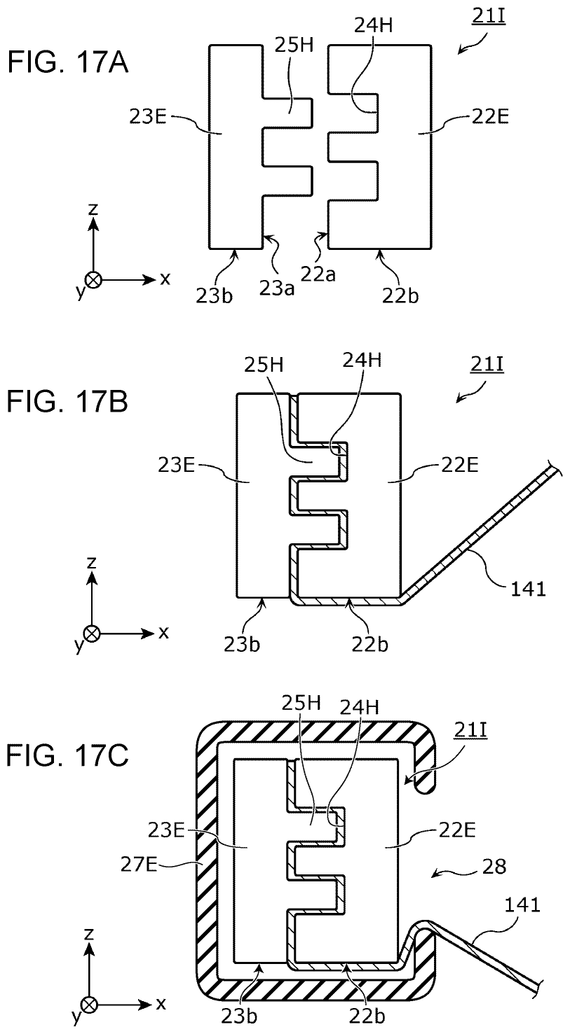

FIG. 17A is a cross-sectional view of an electrode shaft portion 211 according to Modification Example 9. FIG. 17B is a cross-sectional view of the electrode shaft portion 211 according to Modification Example 9 and wound electrode terminal portions 141. FIG. 17C is a cross-sectional view of the electrode shaft portion 211 and an electrode tubular portion 27E according to Modification Example 9 and the wound electrode terminal portions 141.

As illustrated in FIG. 17A, the electrode shaft portion 211 according to the present modification example has a configuration in which the plurality of recesses 24H and the plurality of protrusions 25H of the electrode shaft portion 21H illustrated in FIG. 16A are added to the electrode shaft portion 21E with a rectangular prism shape illustrated in FIG. 13A. With this configuration, as illustrated in FIG. 17B, when the electrode terminal portions 141 are held between the plurality of recesses 24H and the plurality of protrusions 25H, bent portions are formed near the distal ends of the electrode terminal portions 141.

Alternatively, the electrode shaft portion 211 is located in the electrode tubular portion 27E having a shape confirming to the side surfaces of the rectangular prism illustrated in FIG. 13C because the shape of the electrode shaft portion 211 is a rectangular prism. With this configuration, as illustrated in FIG. 17C, when the electrode terminal portions 141 are held between the plurality of recesses 24H and the plurality of protrusions 25H, bent portions are formed near the distal ends of the electrode terminal portions 141.

With the present modification example, it is possible to further increase the reliability of the battery 1 or 2 and the energy density of the battery 1.

### Modification Example 10

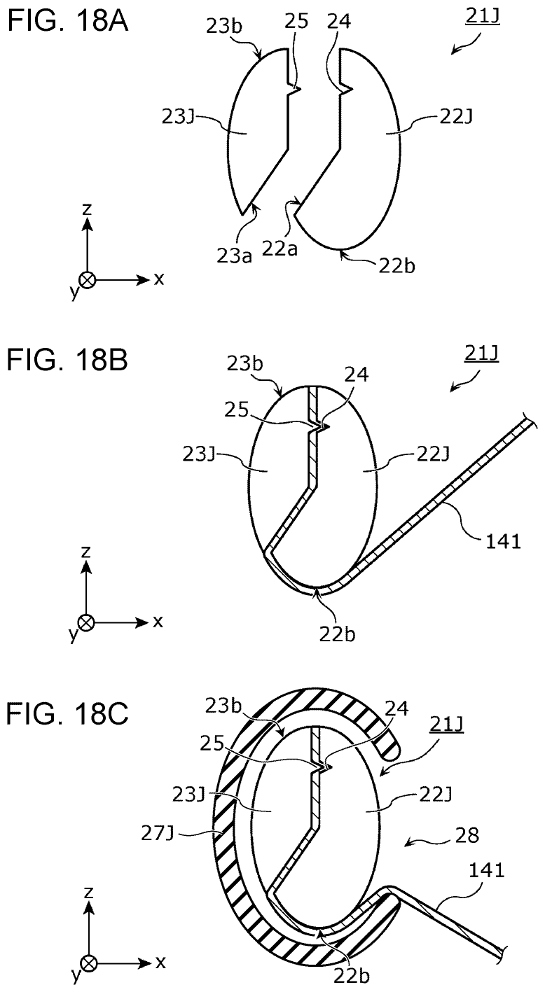

FIG. 18A is a cross-sectional view of an electrode shaft portion 21J according to Modification Example 10. FIG. 18B is a cross-sectional view of the electrode shaft portion 21J according to Modification Example 10 and wound electrode terminal portions 141. FIG. 18C is a cross-sectional view of the electrode shaft portion 21J and an electrode tubular portion 27J according to Modification Example 10 and the wound electrode terminal portions 141.

As illustrated in FIG. 18A, the shape of the electrode shaft portion 21J according to the present modification example is an elliptical cylinder extending in the axial direction. Specifically, the electrode shaft portion 21J includes a first shaft member 22J and a second shaft member 23J. The first shaft member 22J and the second shaft member 23J are configured to form an elliptical cylinder when combined. In other words, each of the outer surface 22b of the first shaft member 22J and the outer surface 23b of the second shaft member 23J has a shape of a side surface of an elliptical cylinder. As illustrated in FIG. 18B, the electrode terminal portions 141 are wound along the side surface of the outer surface 22b.

The major axis of the ellipse that is the shape of the bottom surface or the cross section of the electrode shaft portion 21J is parallel to the thickness direction of the power-generation element 10, and the minor axis of the ellipse is orthogonal to the thickness direction of the power-generation element 10. Since this configuration makes the portion of the electrode shaft portion 21J farthest from the power-generation element 10 closer to the power-generation element 10, the overall size of the battery 1 can be smaller. Since the volume of the portions of the battery 1 not contributing charging and discharging can be smaller, it further increases the energy density of the battery 1.

Alternatively, as illustrated in FIG. 18C, the electrode tubular portion 27J according to the present modification example is a tubular member having a shape conforming to the outer surface of the electrode shaft portion 21J having an elliptical cylinder shape. Specifically, the electrode tubular portion 27J has a cross section having an elliptical outline a part of which is open. The first shaft member 22J and the second shaft member 23J are combined with the distal end portions of the electrode terminal portions 141 held in between and are stored in the electrode tubular portion 27J.

The major axis of the ellipse that is the shape of the bottom surface or the cross section of each of the electrode shaft portion 21J and the electrode tubular portion 27J is parallel to the thickness direction of the power-generation element 10, and the minor axis of the ellipse is orthogonal to the thickness direction of the power-generation element 10. Since this configuration makes the portion of the electrode tubular portion 27J farthest from the power-generation element 10 closer to the power-generation element 10, the overall size of the battery 2 can be smaller. Since the volume of the portions of the battery 2 not contributing charging and discharging can be smaller, it further increases the energy density of the battery 2.

Note that the major axis of the ellipse that is the shape of the bottom surface or the cross section of the electrode shaft portion 21J may be inclined relative to the thickness direction of the power-generation element 10. The major axis of the ellipse that is the shape of the bottom surface or the cross section of the electrode tubular portion 27J may also be inclined relative to the thickness direction of the power-generation element 10.

### Modification Example 11

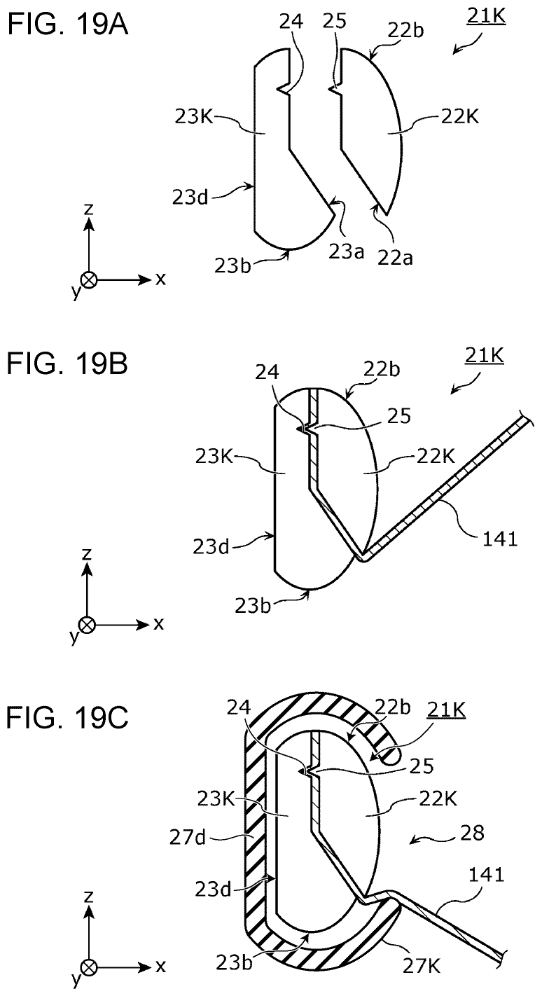

FIG. 19A is a cross-sectional view of an electrode shaft portion 21K according to Modification Example 11. FIG. 19B is a cross-sectional view of the electrode shaft portion 21K according to Modification Example 11 and wound electrode terminal portions 141. FIG. 19C is a cross-sectional view of the electrode shaft portion 21K and an electrode tubular portion 27K according to Modification Example 11 and the wound electrode terminal portions 141.

As illustrated in FIG. 19A, the electrode shaft portion 21K according to the present modification example has an elliptical cylinder shape having a flat surface 23d on its outer surface. The electrode shaft portion 21K includes a first shaft member 22K and a second shaft member 23K. When the first shaft member 22K and the second shaft member 23K are combined, they form an elliptical cylinder having the flat surface 23d. The flat surface 23d is parallel to the thickness direction of the power-generation element 10 and is located on the side opposite to the power-generation element 10.

Since the electrode shaft portion 21K has an elliptical cylinder shape and has the flat surface 23d, the portion of the electrode shaft portion 21K farthest from the power-generation element 10 can be closer to the power-generation element 10, and the overall size of the battery 1 can be smaller. Since the volume of the portions of the battery 1 not contributing charging and discharging can be smaller, it further increases the energy density of the battery 1.

As illustrated in FIG. 19C, the electrode tubular portion 27K according to the present modification example is a tubular member having a shape conforming to the outer surface of the electrode shaft portion 21K having an elliptical cylinder shape a part of which is the flat surface 23d. Specifically, the electrode tubular portion 27K has a flat portion 27d conforming to the flat surface 23d. The flat portion 27d is parallel to the thickness direction of the power-generation element 10 and is located on the side opposite to the power-generation element 10. The electrode tubular portion 27K has a cross section having a shape conforming to the outline of an ellipse except the flat portion 27d, and a part of the ellipse is open.

Since the electrode tubular portion 27K has a shape conforming to the side surface of an elliptical cylinder and also has the flat portion 27d, the portion of the electrode tubular portion 27K farthest from the power-generation element 10 can be closer to the power-generation element 10, and the overall size of the battery 2 can be smaller. Since the volume of the portions of the battery 2 not contributing charging and discharging can be smaller, it further increases the energy density of the battery 2.

### Modification Example 12

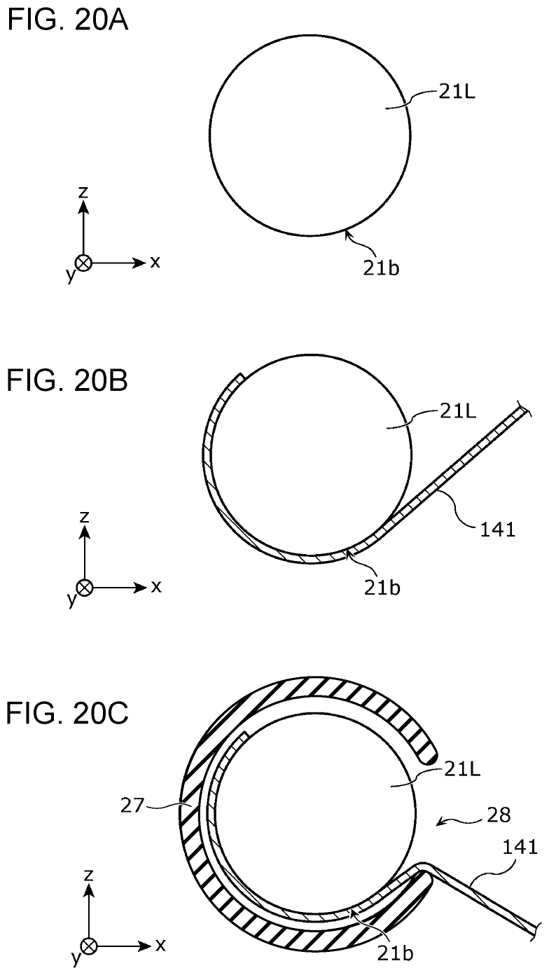

FIG. 20A is a cross-sectional view of an electrode shaft portion 21L according to Modification Example 12. FIG. 20B is a cross-sectional view of the electrode shaft portion 21L according to Modification Example 12 and wound electrode terminal portions 141. FIG. 20C is a cross-sectional view of the electrode shaft portion 21L and an electrode tubular portion 27 according to Modification Example 12 and the wound electrode terminal portions 141.

As illustrated in FIG. 20A, the electrode shaft portion 21L according to the present modification example is composed of only one member having a circular cylinder shape, as with the electrode shaft portion 21P according to Embodiment 2. The electrode shaft portion 21L does not have the groove 21c illustrated in FIG. 8. Hence, as illustrated in FIG. 20B, the electrode terminal portions 141 are wound around and fixed to the outer surface 21b of the electrode shaft portion 21L. Alternatively, as illustrated in FIG. 20C, the electrode terminal portions 141 pass through an opening 28 of the electrode tubular portion 27 and are wound around and fixed to the outer surface 21b of the electrode shaft portion 21L. The fixation is performed, for example, by thermal-bonding, bonding with an adhesive, or other methods.

The present modification example also enables the electrode terminal portions 141 to be stored compactly as with other modification examples, increasing the energy density of the battery 1 or 2. Since the electrode shaft portion 21L has a simple structure, it is possible to increase the productivity of the battery 1 or 2.

### Modification Example 13

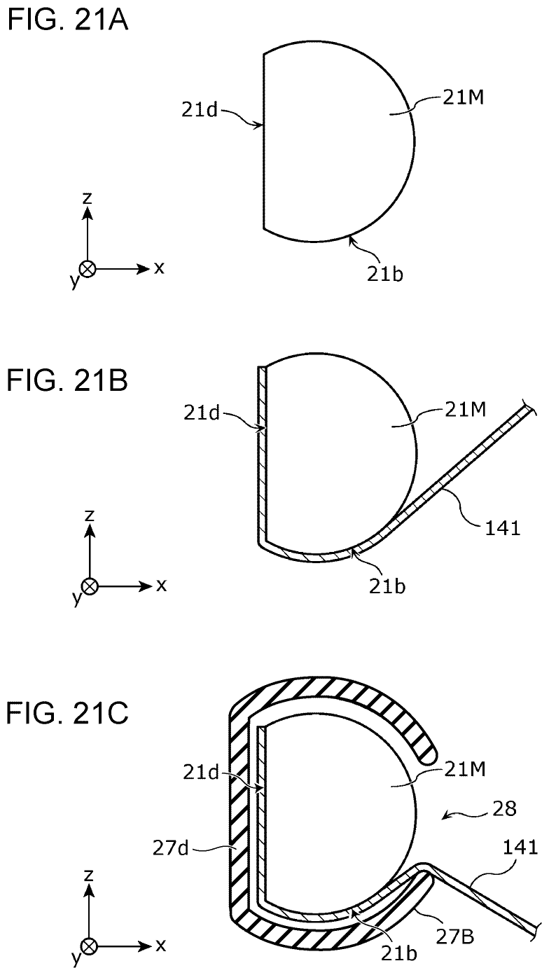

FIG. 21A is a cross-sectional view of an electrode shaft portion 21M according to Modification Example 13. FIG. 21B is a cross-sectional view of the electrode shaft portion 21M according to Modification Example 13 and wound electrode terminal portions 141. FIG. 21C is a cross-sectional view of the electrode shaft portion 21M and an electrode tubular portion 27B according to Modification Example 13 and the wound electrode terminal portions 141.

As illustrated in FIG. 21A, the electrode shaft portion 21M according to the present modification example is composed of only one member having a circular cylinder shape, as in Modification Example 12, and has a flat surface 21d on its outer surface. The flat surface 21d is parallel to the thickness direction of the power-generation element 10 and is located on the side opposite to the power-generation element 10.

As illustrated in FIG. 21B, the electrode terminal portions 141 are wound around and fixed to the flat surface 21d of the electrode shaft portion 21M. Alternatively, as illustrated in FIG. 21C, the electrode terminal portions 141 pass through an opening 28 of the electrode tubular portion 27B and are wound around and fixed to the flat surface 21d of the electrode shaft portion 21M. The fixation is performed, for example, by thermal-bonding, bonding with an adhesive, or other methods.

Forming the flat surface 21d makes the portion of the electrode shaft portion 21M farthest from the power-generation element 10 closer to the power-generation element 10. Forming the flat portion 27d makes the portion of the electrode tubular portion 27B farthest from the power-generation element 10 closer to the power-generation element 10. This enables the overall size of the battery 1 or 2 to be smaller. Since the volume of the portions of the battery 1 or 2 not contributing charging and discharging can be smaller, it further increases the energy density of the battery 1 or 2.

### Modification Example 14

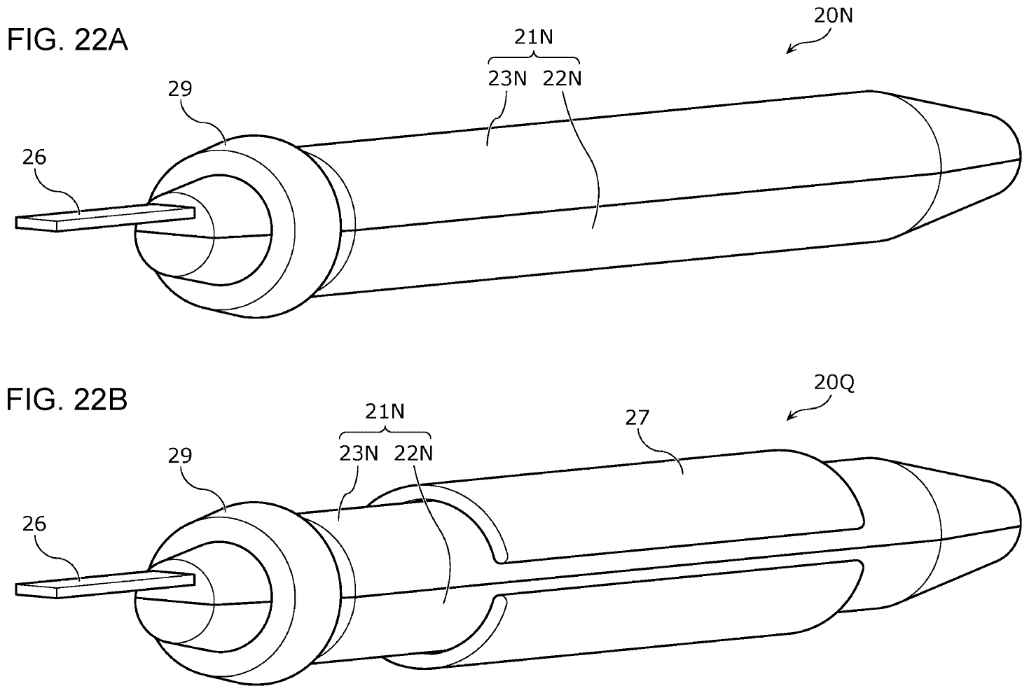

FIG. 22A is a perspective view of an electrode core member 20N according to Modification Example 14. FIG. 22B is a perspective view of an electrode core member 20Q according to Modification Example 14.

As illustrated in FIG. 22A, the electrode core member 20N includes an electrode shaft portion 21N, an electrode outer terminal 26, and a ring-shaped member 29. As illustrated in FIG. 22B, the electrode core member 20Q includes the electrode shaft portion 21N, the electrode outer terminal 26, an electrode tubular portion 27, and the ring-shaped member 29. The electrode shaft portion 21N includes a first shaft member 22N and a second shaft member 23N.

The first shaft member 22N and the second shaft member 23N have configurations the same as or similar to those of the first shaft member 22 and the second shaft member 23 illustrated in FIGS. 2 and 5 but differ from them in that the axially distal end portions of the first shaft member 22N and the second shaft member 23N are tapered. Specifically, in the first shaft member 22N and the second shaft member 23N, both axial ends have tapered shapes. More specifically, as illustrated in FIGS. 22A and 22B, both axial ends of the electrode shaft portion 21N have conical frustum shapes.

The ring-shaped member 29 is configured to fix the first shaft member 22N and the second shaft member 23N. The first shaft member 22N and the second shaft member 23N in the state of being combined are inserted into the ring-shaped member 29.

Specifically, the ring-shaped member 29 has a shape conforming to the side surface of a conical frustum. When the electrode shaft portion 21N is axially inserted into the ring-shaped member 29, the inner peripheral surface of the ring-shaped member 29 is fitted with the tapered distal-end portion of the electrode shaft portion 21N. With this process, the first shaft member 22N and the second shaft member 23N are fixed.

Note that the electrode core member 20N may include two ring-shaped members 29. The two the ring-shaped member 29 may be attached to the two axial ends of the electrode shaft portion 21N. This enables the first shaft member 22N and the second shaft member 23N to be fixed more firmly, enabling the electrode terminal portions 141 (not illustrated) between these members to be firmly fixed.

### Outer Case

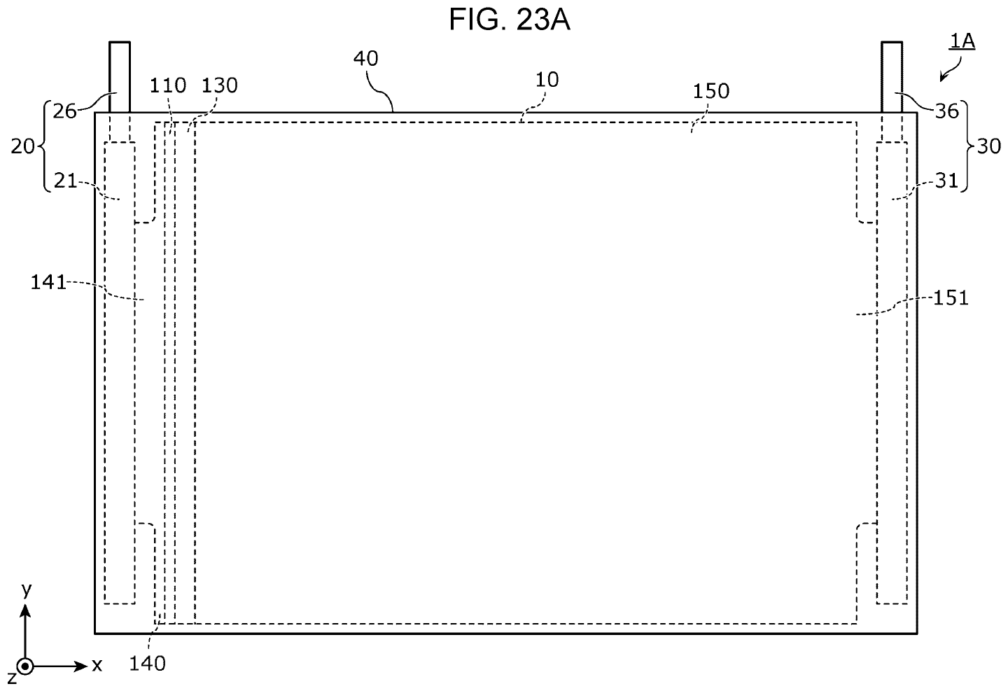

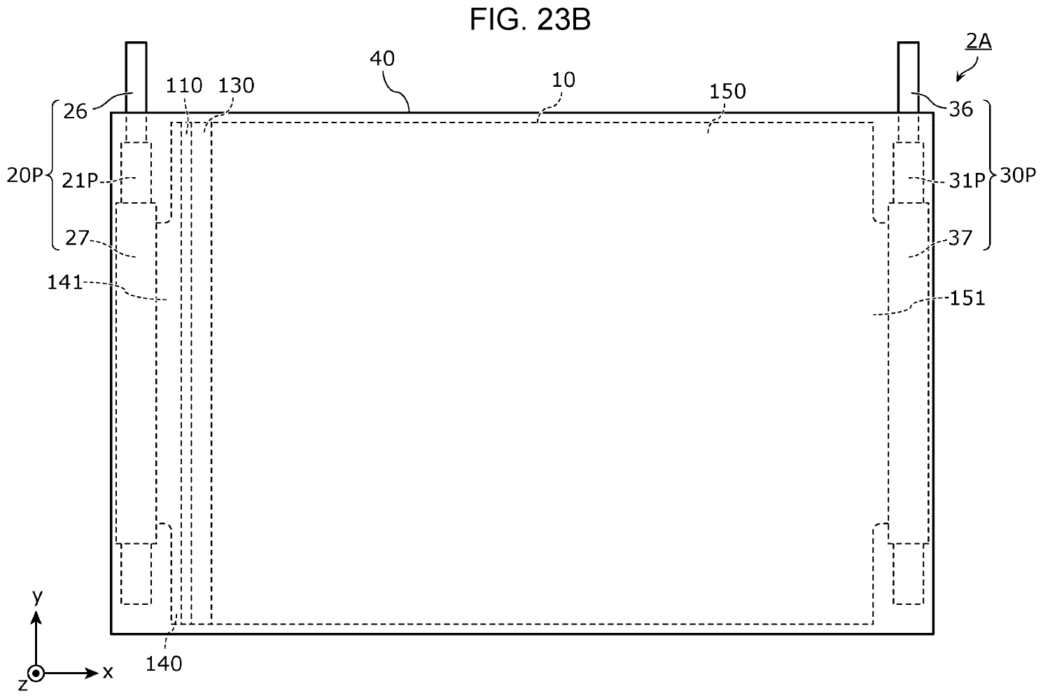

The battery 1 illustrated in FIG. 1 is, for example, inserted into an outer case. Similarly, the battery 2 illustrated in FIG. 6 may be, for example, inserted into an outer case. In the following, a configuration of a battery including an outer case will be described with reference to FIGS. 23A and 23B.

FIG. 23A is a plan view of a battery 1A according to a modification example of Embodiment 1. As illustrated in FIG. 23A, the battery 1A includes a power-generation element 10, an electrode core member 20, a counter-electrode core member 30, and an outer case 40.

The outer case 40 houses the power-generation element 10. The outer case 40 is composed of, for example, two facing lamination films the outer peripheral portions of which are thermally bonded by thermocompression bonding. Alternatively, the outer case 40 may be one lamination film in the form of a bag.

As illustrated in FIG. 23A, the outer case 40 houses at least part of each of the electrode core member 20 and the counter-electrode core member 30. Specifically, the electrode shaft portion 21 of the electrode core member 20 and the counter-electrode shaft portion 31 of the counter-electrode core member 30 are housed in the outer case 40. In other words, both the electrode terminal portions 141 and the counter-electrode terminal portions 151 of the power-generation element 10 are housed in the outer case 40.

The electrode outer terminal 26 of the electrode core member 20 and the counter-electrode outer terminal 36 of the counter-electrode core member 30 extend to the outside of the outer case 40. With this configuration, the electrode outer terminal 26 and the counter-electrode outer terminal 36 can be used for electrical connection to another device or the like.

FIG. 23B is a plan view of a battery 2A according to a modification example of Embodiment 2. As illustrated in FIG. 23B, the battery 2A includes a power-generation element 10, an electrode core member 20P, a counter-electrode core member 30P, and an outer case 40.

As illustrated in FIG. 23B, the outer case 40 houses at least part of each of the electrode core member 20P and the counter-electrode core member 30P. Specifically, the electrode shaft portion 21P and the electrode tubular portion 27 of the electrode core member 20P and the counter-electrode shaft portion 31P and the counter-electrode tubular portion 37 of the counter-electrode core member 30P are housed in the outer case 40. In other words, the electrode terminal portions 141 and the counter-electrode terminal portions 151 of the power-generation element 10 are housed in the outer case 40.

The electrode outer terminal 26 of the electrode core member 20P and the counter-electrode outer terminal 36 of the counter-electrode core member 30P extend to the outside of the outer case 40. With this configuration, the electrode outer terminal 26 and the counter-electrode outer terminal 36 can be used for electrical connection to another device or the like.

Since the power-generation element 10 is housed in the outer case 40 as described above, the power-generation element 10 can be protected and prevented from deteriorating. In the battery 1A, not only the power-generation element 10 but also the electrode shaft portion 21 and the counter-electrode shaft portion 31 are enclosed together in the outer case 40, and only the electrode outer terminal 26 and the counter-electrode outer terminal 36 extend to the outside of the outer case 40. Hence, the degree of sealing of the outer case 40 can be high. Similarly, in the battery 2A, not only the power-generation element 10 but also the electrode shaft portion 21P and the electrode tubular portion 27, and the counter-electrode shaft portion 31P and the counter-electrode tubular portion 37 are enclosed together in the outer case 40, and only the electrode outer terminal 26 and the counter-electrode outer terminal 36 extend to the outside of the outer case 40. Hence, the degree of sealing of the outer case 40 can be high. Hence, connection to another device and the like is easy, and also, the reliability of the battery 1A or 2A is high.

Although the description is based on an example in which the outer case 40 is composed of lamination film, the present disclosure is not limited to this configuration. The outer case 40 may be a metal can, a resin case, or the like.

The outer case 40 may house a plurality of laminated power-generation elements 10. Each power-generation element 10 includes an electrode core member 20 or 20P and a counter-electrode core member 30 or 30P, and the electrode core members 20 or 20P and the counter-electrode core members 30 or 30P are aligned in the laminating direction. Since the thickness of the electrode core member 20 or 20P and the counter-electrode core member 30 or 30P is smaller than the thickness of power-generation element 10 in the present modification example, the plurality of electrode core members 20 or 20P and the plurality of counter-electrode core members 30 or 30P, when the plurality of power-generation elements 10 are laminated, do not interfere with one another. This makes it possible to increase the degree of sealing of the outer case 40. This configuration prevents the thickness of the battery 1A or 2A from increasing due to interferences of the electrode core members 20 or 20P and the counter-electrode core members 30 or 30P, increasing the energy density of the battery 1A or 2A.

### Modification Example of Outer Connection Terminals

Although the electrode outer terminal 26 and the counter-electrode outer terminal 36 extend in the axial direction in the battery 1 illustrated in FIG. 1 and the battery 2 illustrated in FIG. 6, the present disclosure is not limited to this configuration.

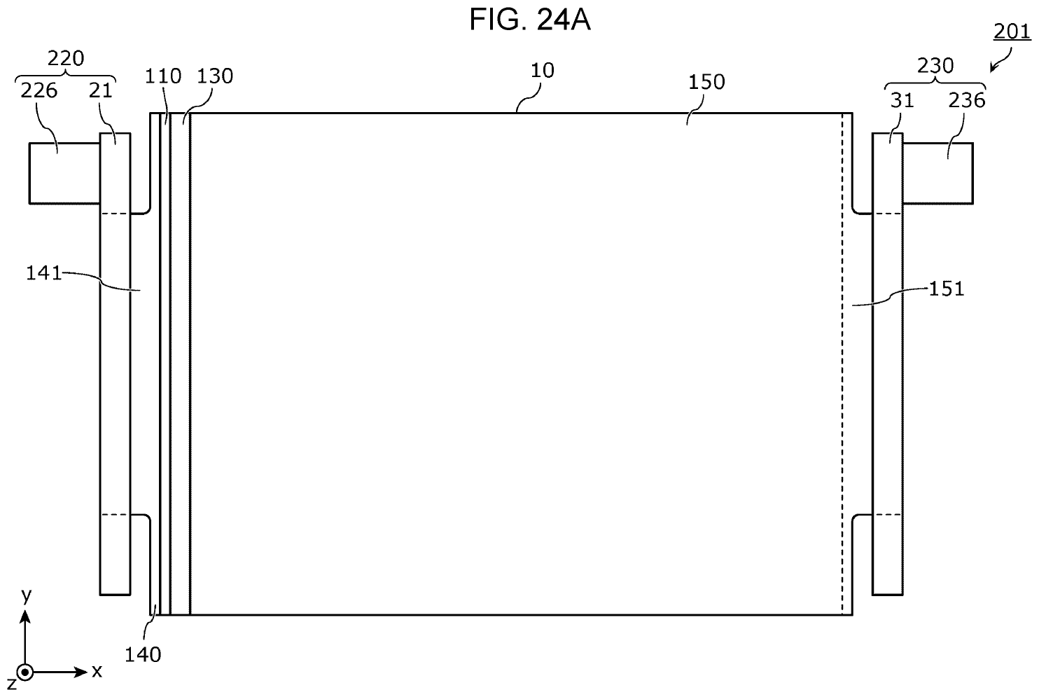

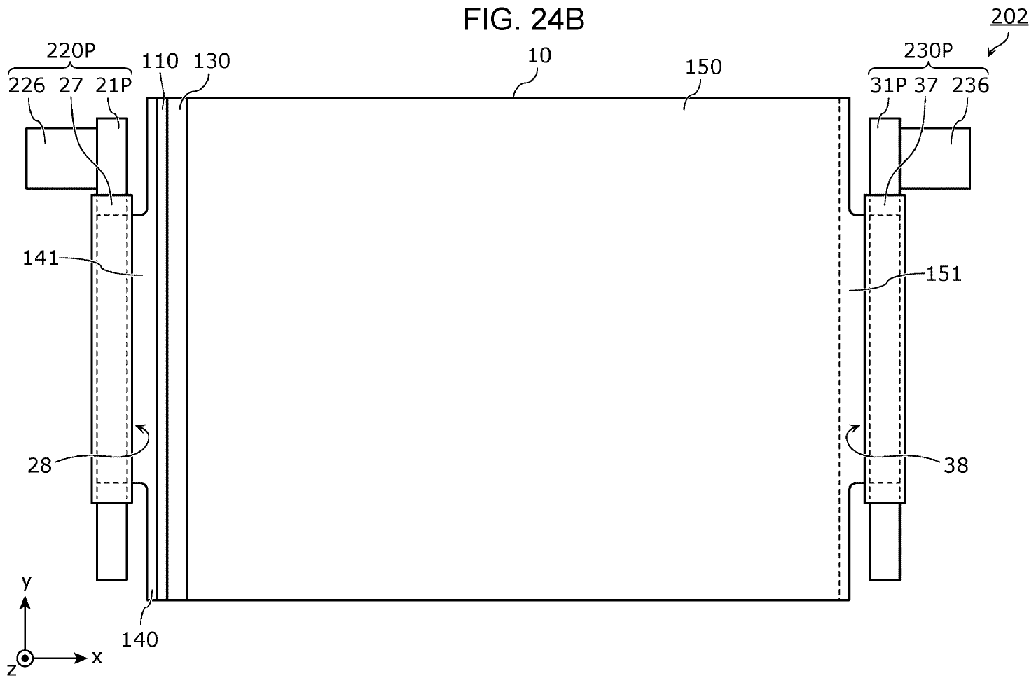

FIG. 24A is a plan view of a battery 201 according to a modification example of Embodiment 1. As illustrated in FIG. 24A, the battery 201 includes a power-generation element 10, an electrode core member 220, and a counter-electrode core member 230.

The electrode core member 220 includes an electrode shaft portion 21 and an electrode outer terminal 226. The electrode outer terminal 226 extends from the surface of the electrode shaft portion 21 opposite to the power-generation element 10 in a direction away from the power-generation element 10. In the example illustrated in FIG. 24A, the electrode outer terminal 226 is a plate-shaped portion extending in the negative direction of the x-axis from a portion that the electrode terminal portions 141 are not wound around in the two end portions of the electrode shaft portion 21.

The counter-electrode core member 230 includes a counter-electrode shaft portion 31 and a counter-electrode outer terminal 236. The counter-electrode outer terminal 236 extends from the surface of the counter-electrode shaft portion 31 opposite to the power-generation element 10 in a direction away from the power-generation element 10. The counter-electrode outer terminal 236 is a plate-shaped portion extending in the positive direction of the x-axis from a portion that the counter-electrode terminal portions 151 are not wound around in the two end portions of the counter-electrode shaft portion 31.

FIG. 24B is a plan view of a battery 202 according to a modification example of Embodiment 2. As illustrated in FIG. 24B, the battery 202 includes a power-generation element 10, an electrode core member 220P, and a counter-electrode core member 230P.

The electrode core member 220P includes an electrode shaft portion 21P, an electrode tubular portion 27, and an electrode outer terminal 226. The electrode outer terminal 226 extends from the surface of the electrode shaft portion 21P opposite to the power-generation element 10 in a direction away from the power-generation element 10. In the example illustrated in FIG. 24B, the electrode outer terminal 226 is a plate-shaped portion extending in the negative direction of the x-axis from a portion that the electrode terminal portions 141 are not wound around and that is not covered with the electrode tubular portion 27, in the two end portions of the electrode shaft portion 21P.

The counter-electrode core member 230P includes a counter-electrode shaft portion 31P, a counter-electrode tubular portion 37, and a counter-electrode outer terminal 236. The counter-electrode outer terminal 236 extends from the surface of the counter-electrode shaft portion 31P opposite to the power-generation element 10 in a direction away from the power-generation element 10. The counter-electrode outer terminal 236 is a plate-shaped portion extending in the positive direction of the x-axis from a portion that the counter-electrode terminal portions 151 are not wound around and that is not covered with the counter-electrode tubular portion 37, in the two end portions of the counter-electrode shaft portion 31P.

The electrode outer terminal 226 and the counter-electrode outer terminal 236 are used for electrical connection to another device. For example, in the case in which the battery 201 or 202 includes the outer case 40 illustrated in FIG. 23A or FIG. 23B, the electrode outer terminal 226 and the counter-electrode outer terminal 236 are located outside the outer case 40.

Note that the extending directions of the electrode outer terminal 226 and the counter-electrode outer terminal 236 are not limited to the examples illustrated in FIGS. 24A and 24B. For example, the extending directions of the electrode outer terminal 226 and the counter-electrode outer terminal 236 may be the direction parallel to the thickness direction (the z-axis direction) of the power-generation element 10 or may be oblique directions relative to the thickness direction. Alternatively, the extending directions of the electrode outer terminal 226 and the counter-electrode outer terminal 236 may be oblique directions relative to the axial direction of each core member.

The extending directions of the electrode outer terminal 226 and the counter-electrode outer terminal 236 may be adjusted as appropriate depending on the configuration that the battery 201 or 202 is to be connected to or mounted on.

### Embodiment 3

Next, Embodiment 3 will be described.

Embodiment 3 differs from Embodiment 1 in that one common core member serves as the electrode core member and the counter-electrode core member. The following description focuses on the differences from Embodiment 1, and description of common points is omitted or simplified.

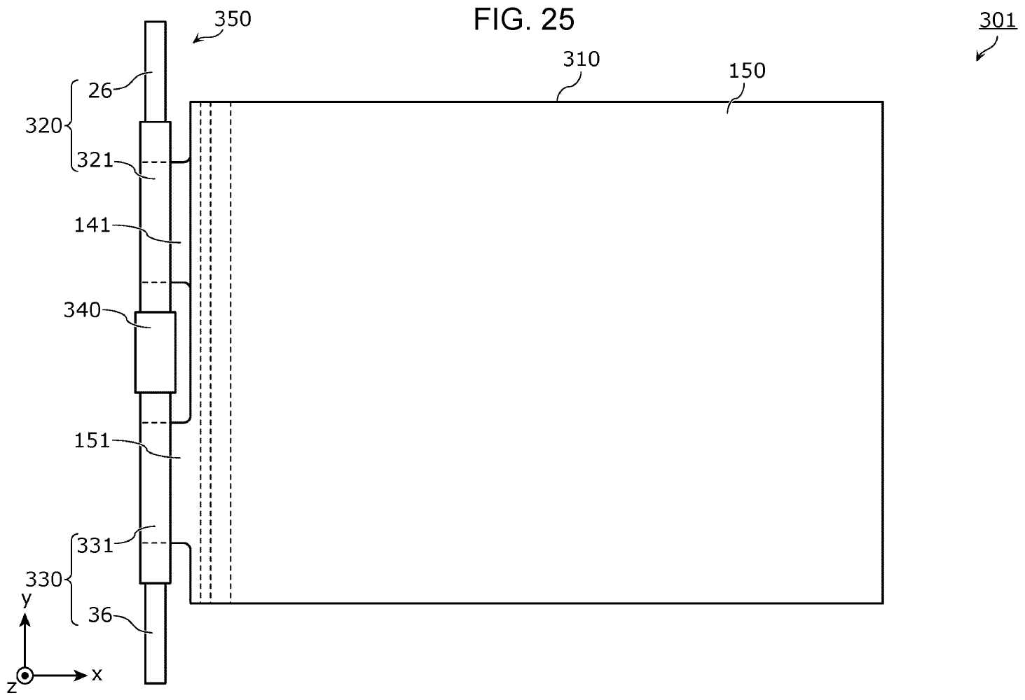

FIG. 25 is a plan view of a battery 301 according to the present embodiment. As illustrated in FIG. 25, the battery 301 includes a power-generation element 310 and a bipolar core member 350.

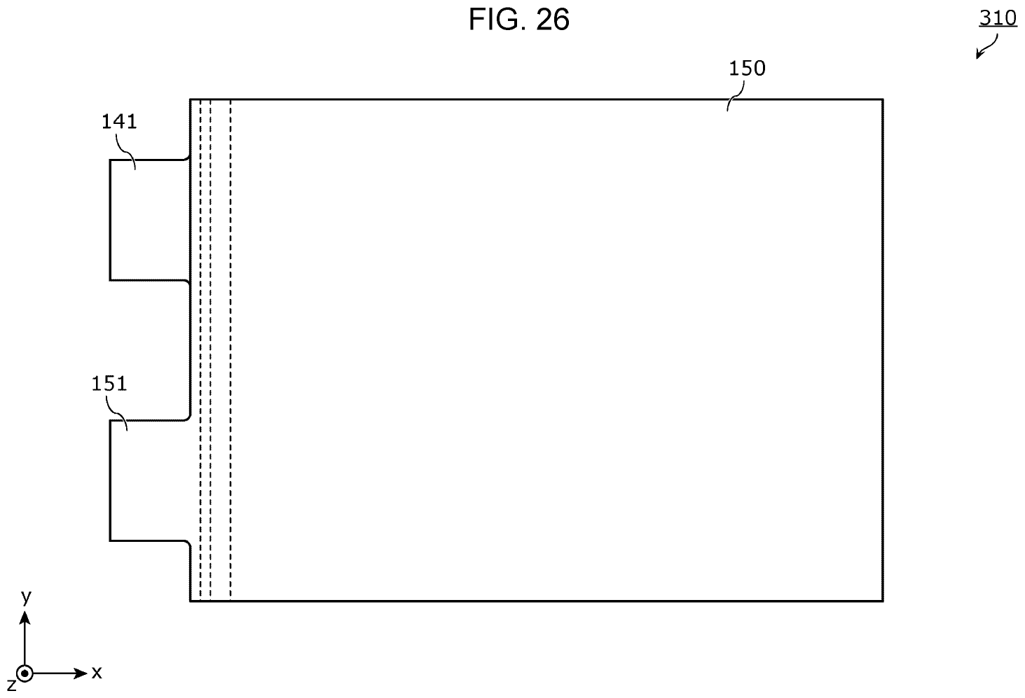

In the power-generation element 310, the positions and sizes of the electrode terminal portions 141 and the counter-electrode terminal portions 151 differ from those of the power-generation element 10 according to Embodiment 1. FIG. 26 is a plan view of the power-generation element 310 of the battery 301 according to the present embodiment before the bipolar core member 350 is attached to it. As illustrated in FIG. 26, the electrode terminal portions 141 and the counter-electrode terminal portions 151 are located on the same side surface of the power-generation element 310.

The bipolar core member 350 includes an electrode core member 320, a counter-electrode core member 330, and an insulating member 340. The bipolar core member 350 is one core member into which the electrode core member 320 and the counter-electrode core member 330 are integrated with the insulating member 340 interposed in between.

The electrode core member 320 includes an electrode shaft portion 321 and an electrode outer terminal 26. The electrode shaft portion 321 is an example of a first conductive portion which is electrically connected to the electrode terminal portions 141. The electrode shaft portion 321 differs from the electrode shaft portion 21 according to Embodiment 1 in that the axial length is short. For example, the length of the electrode shaft portion 321 is shorter than half the length of the power-generation element 10 in the y-axis direction. The electrode terminal portions 141 are wound around the electrode shaft portion 321.

The counter-electrode core member 330 includes a counter-electrode shaft portion 331 and a counter-electrode outer terminal 36. The counter-electrode shaft portion 331 is an example of a second conductive portion which is electrically connected to the counter-electrode terminal portions 151. The counter-electrode shaft portion 331 differs from the counter-electrode shaft portion 31 according to Embodiment 1 in that the axial length is short. For example, the length of the counter-electrode shaft portion 331 is shorter than half the length of the power-generation element 10 in the y-axis direction. The counter-electrode terminal portions 151 are wound around the counter-electrode shaft portion 331.

In the present embodiment, the electrode shaft portion 321 and the counter-electrode shaft portion 331 are integrated with the insulating member 340 interposed in between. The electrode shaft portion 321 and the counter-electrode shaft portion 331 are electrically insulated from each other. The concrete configurations of the electrode shaft portion 321 and the counter-electrode shaft portion 331 are the same as that of the electrode shaft portion 21 according to Embodiment 1 or those of its modification examples. The electrode shaft portion 321 and the counter-electrode shaft portion 331 have, for example, the same thickness. This makes it possible to wind the electrode terminal portions 141 and the counter-electrode terminal portions 151 simultaneously.

The insulating member 340 is formed of an electrically insulating material. For example, the insulating member 340 is formed of a resin material, a glass material, or a ceramic material.

The insulating member 340 is located between the electrode shaft portion 321 and the counter-electrode shaft portion 331 and is connected to both the electrode shaft portion 321 and the counter-electrode shaft portion 331. Although the insulating member 340 is thicker than the electrode shaft portion 321 and the counter-electrode shaft portion 331 in FIG. 25, the present disclosure is not limited to this configuration. The insulating member 340 may be thinner than or may have the same thickness as the electrode shaft portion 321 and the counter-electrode shaft portion 331.

Use of the bipolar core member 350 makes it possible to wind the electrode terminal portions 141 and the counter-electrode terminal portions 151 simultaneously. This simplifies the manufacturing steps of the battery 301, increasing the productivity.

In addition, since the bipolar core member 350 is located along one side of the power-generation element 310 in plan view, no member needs to located on the other three sides. This arrangement further reduces the volume of the portions of the battery 301 not contributing charging and discharging, further increasing the energy density of the battery 301.

Note that the bipolar core member may include an electrode tubular portion and a counter-electrode tubular portion as in the battery 2 according to Embodiment 2.

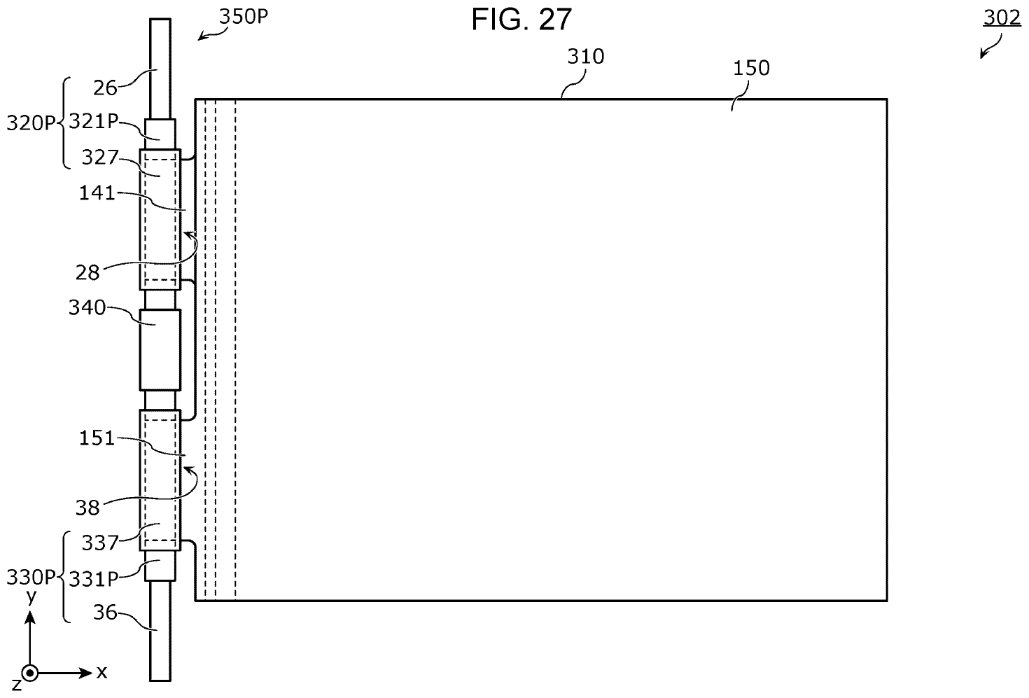

FIG. 27 is a plan view of a battery 302 according to a modification example of the present embodiment. As illustrated in FIG. 27, the battery 302 includes a power-generation element 310 and a bipolar core member 350P.

The bipolar core member 350P includes an electrode core member 320P, a counter-electrode core member 330P, and an insulating member 340. The bipolar core member 350P is one core member into which the electrode core member 320P and the counter-electrode core member 330P are integrated with the insulating member 340 interposed in between.

The electrode core member 320P includes an electrode shaft portion 321P, an electrode outer terminal 26, and an electrode tubular portion 327.

The electrode shaft portion 321P is an example of a first conductive portion which is electrically connected to the electrode terminal portions 141. The electrode shaft portion 321P differs from the electrode shaft portion 21P according to Embodiment 2 in that the axial length is short. For example, the length of the electrode shaft portion 321P is shorter than half the length of the power-generation element 10 in the y-axis direction. The electrode terminal portions 141 are wound around the electrode shaft portion 321P.

The electrode tubular portion 327 is an example of a first tubular portion in which the electrode shaft portion 321P is located. The electrode tubular portion 327 differs from the electrode tubular portion 27 according to Embodiment 2 in that the axial length is short. For example, the length of the electrode tubular portion 327 is shorter than or equal to the length of the electrode shaft portion 321P. The electrode tubular portion 327 has an opening 28 which is an example of a first opening as with the electrode tubular portion 27.

The counter-electrode core member 330P includes a counter-electrode shaft portion 331P, a counter-electrode outer terminal 36, and a counter-electrode tubular portion 337.

The counter-electrode shaft portion 331P is an example of a second conductive portion which is electrically connected to the counter-electrode terminal portions 151. The counter-electrode shaft portion 331P differs from the counter-electrode shaft portion 31P according to Embodiment 2 in that the axial length is short. For example, the length of the counter-electrode shaft portion 331P is shorter than half the length of the power-generation element 10 in the y-axis direction. The counter-electrode terminal portions 151 are wound around the counter-electrode shaft portion 331P.

The counter-electrode tubular portion 337 is an example of a second tubular portion in which the counter-electrode shaft portion 331P is located. The counter-electrode tubular portion 337 differs from the counter-electrode tubular portion 37 according to Embodiment 2 in that the axial length is short. For example, the length of the counter-electrode tubular portion 337 is shorter than or equal to the length of the counter-electrode shaft portion 331P. The counter-electrode tubular portion 337 has an opening 38 which is an example of a second opening as with the counter-electrode tubular portion 37.

In the present embodiment, the electrode shaft portion 321P and the counter-electrode shaft portion 331P are integrated with the insulating member 340 interposed in between. The electrode shaft portion 321P and the counter-electrode shaft portion 331P are electrically insulated from each other. The concrete configurations of the electrode shaft portion 321P and the counter-electrode shaft portion 331P are the same as that of the electrode shaft portion 21P according to Embodiment 2 or those of its modification examples. The electrode shaft portion 321P and the counter-electrode shaft portion 331P have, for example, the same thickness. This makes it possible to wind the electrode terminal portions 141 and the counter-electrode terminal portions 151 simultaneously.

Use of the bipolar core member 350P makes it possible to wind the electrode terminal portions 141 and the counter-electrode terminal portions 151 simultaneously. This simplifies the manufacturing steps of the battery 302, increasing the productivity.

In addition, since the bipolar core member 350P is located on one side of the power-generation element 310 in plan view, no member needs to be located on the other three sides. This arrangement further reduces the volume of the portions of the battery 302 not contributing charging and discharging, further increasing the energy density of the battery 302.

In the case in which the electrode tubular portion 327 and the counter-electrode tubular portion 337 are formed of an insulating material in the battery 302, the electrode tubular portion 327 and the counter-electrode tubular portion 337 may be one integrated tubular portion. Specifically, one tubular portion may cover the electrode shaft portion 321, the counter-electrode shaft portion 331, and the insulating member 340.

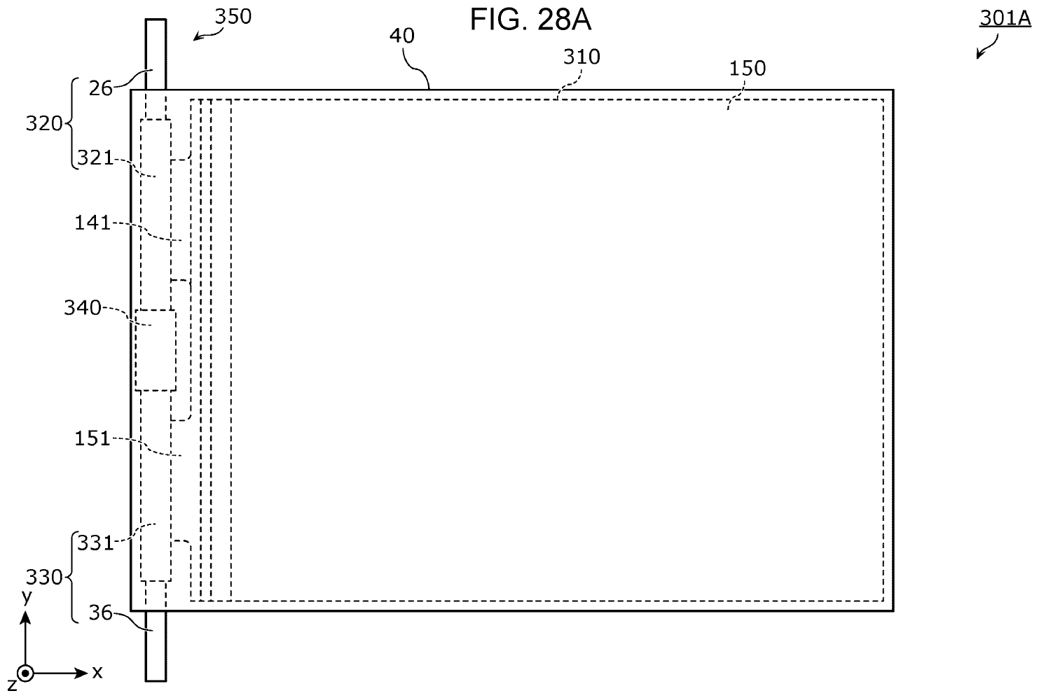

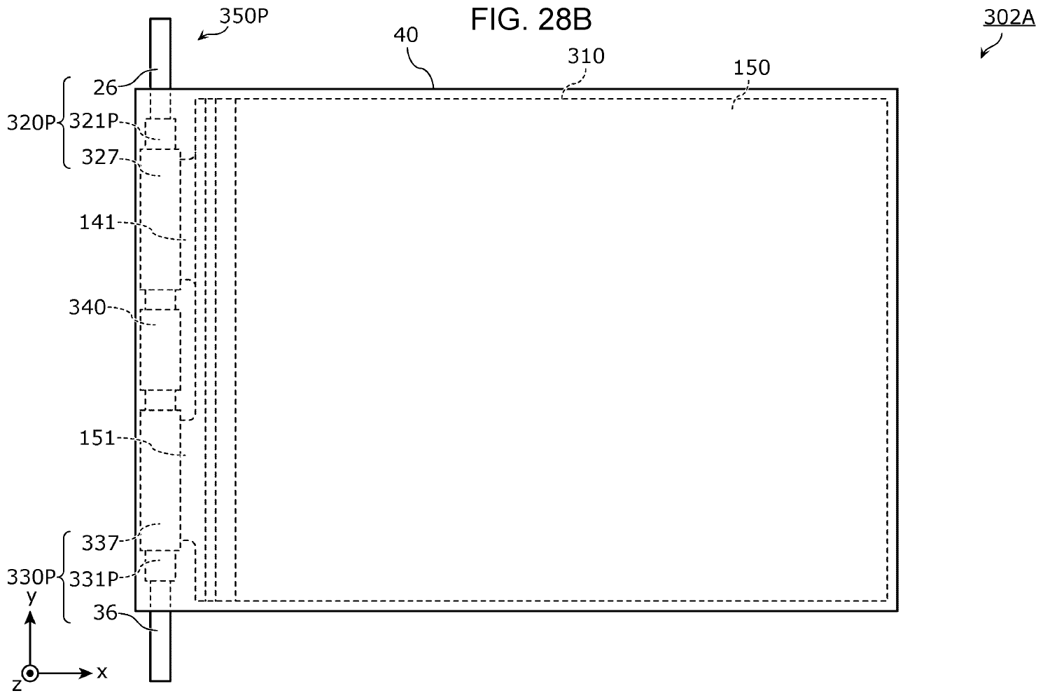

The battery 301 illustrated in FIG. 25 may be inserted into an outer case as in the modification example of Embodiment 1. FIG. 28A is a plan view of a battery 301A according to a modification example of the present embodiment. As illustrated in FIG. 28A, the battery 301A includes a power-generation element 310, a bipolar core member 350, and an outer case 40. The outer case 40 is the same as that in the modification example of Embodiment 1.

Similarly, the battery 302 illustrated in FIG. 27 may be inserted into an outer case as in the modification example of Embodiment 2. FIG. 28B is a plan view of a battery 302A according to a modification example of the present embodiment. As illustrated in FIG. 28B, the battery 302A includes a power-generation element 310, a bipolar core member 350P, and an outer case 40.

In the case in which the power-generation element 310 is housed in the outer case 40, the three sides where the bipolar core member 350 is not located, of the four sides of the power-generation element 310 in plan view, can be in close contact with the inner surfaces of the outer case 40. This enables downsizing of the battery 301A or 302A and increasing the energy density.

Although the electrode outer terminal 26 and the counter-electrode outer terminal 36 extend in the axial direction in the battery 301 illustrated in FIG. 25 and the battery 302 illustrated in FIG. 27, the present disclosure is not limited to this configuration.

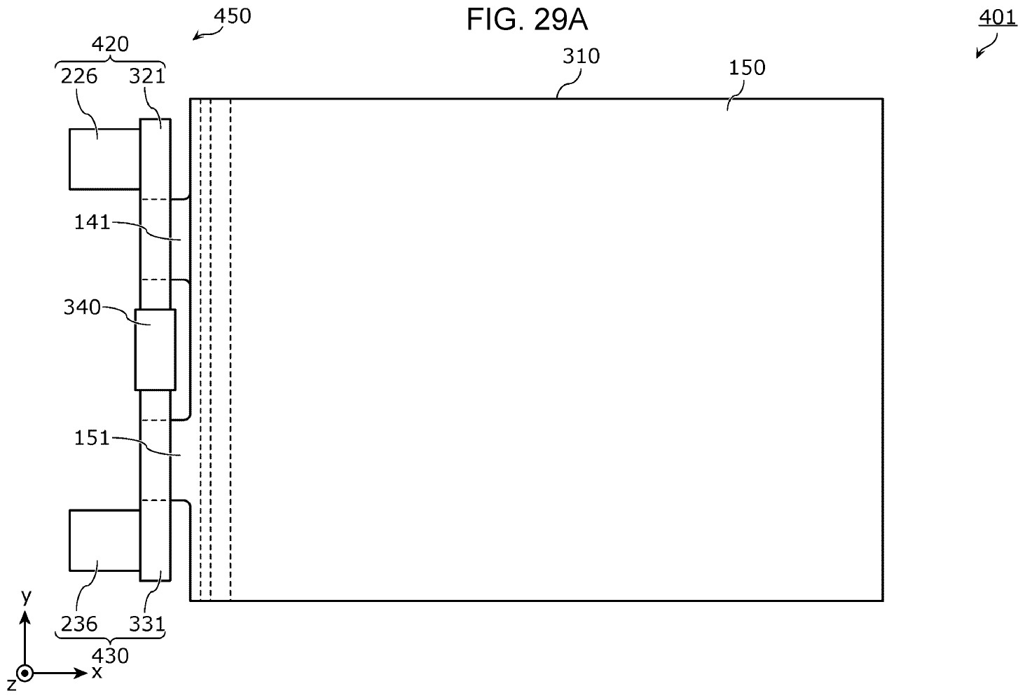

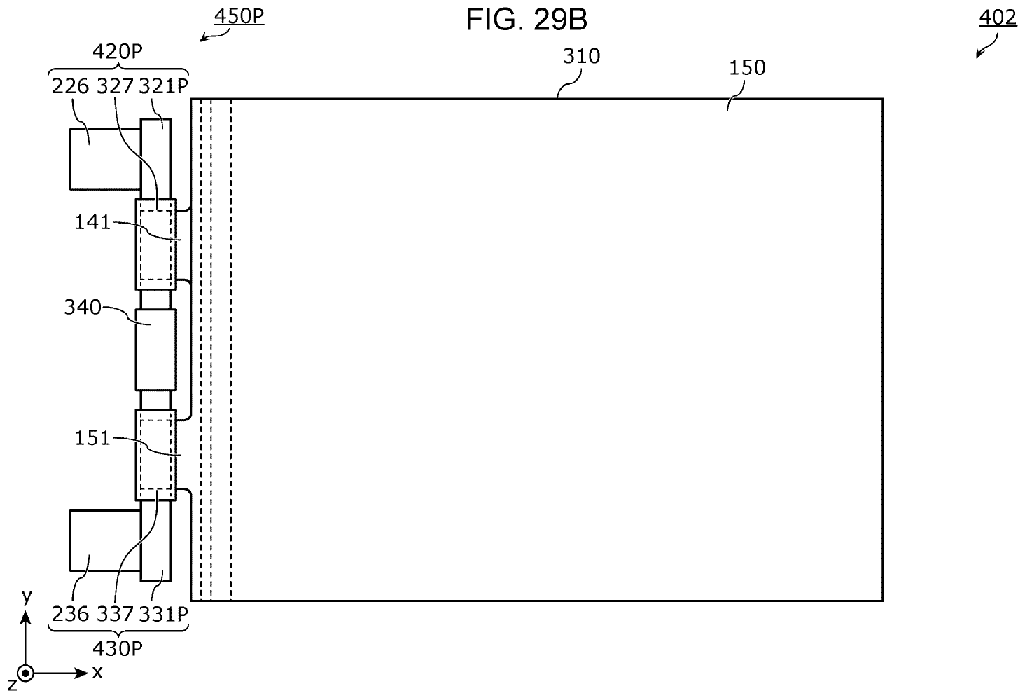

FIG. 29A is a plan view of a battery 401 according to a modification example of the present embodiment. As illustrated in FIG. 29A, the battery 401 includes a power-generation element 310 and a bipolar core member 450. The bipolar core member 450 includes an electrode core member 420, a counter-electrode core member 430, and an insulating member 340.

The electrode core member 420 includes an electrode shaft portion 321 and an electrode outer terminal 226. As in FIG. 24A, the electrode outer terminal 226 extends from the surface of the electrode shaft portion 321 opposite to the power-generation element 310 in a direction away from the power-generation element 310. In the example illustrated in FIG. 29A, the electrode outer terminal 226 is a plate-shaped portion extending in the negative direction of the x-axis from a portion that the electrode terminal portions 141 are not wound around in the end portion of the electrode shaft portion 321.

The counter-electrode core member 430 includes a counter-electrode shaft portion 331 and a counter-electrode outer terminal 236. The counter-electrode outer terminal 236 extends from the surface of the counter-electrode shaft portion 331 opposite to the power-generation element 310 in a direction away from the power-generation element 310. The counter-electrode outer terminal 236 is a plate-shaped portion extending in the negative direction of the x-axis from a portion that the counter-electrode terminal portions 151 are not wound around in the end portion of the counter-electrode shaft portion 331.

FIG. 29B is a plan view of a battery 402 according to a modification example of the present embodiment. As illustrated in FIG. 29B, the battery 402 includes a power-generation element 310 and a bipolar core member 450P. The bipolar core member 450P includes an electrode core member 420P, a counter-electrode core member 430P, and an insulating member 340.

The electrode core member 420P includes an electrode shaft portion 321P, an electrode tubular portion 327, and an electrode outer terminal 226. As in FIG. 24B, the electrode outer terminal 226 extends from the surface of the electrode shaft portion 321P opposite to the power-generation element 310 in a direction away from the power-generation element 310. In the example illustrated in FIG. 29B, the electrode outer terminal 226 is a plate-shaped portion extending in the negative direction of the x-axis from a portion that the electrode terminal portions 141 are not wound around and that is not covered with the electrode tubular portion 327, in the end portion of the electrode shaft portion 321P.

The counter-electrode core member 430P includes a counter-electrode shaft portion 331P, a counter-electrode tubular portion 337, and a counter-electrode outer terminal 236. The counter-electrode outer terminal 236 extends from the surface of the counter-electrode shaft portion 331P opposite to the power-generation element 310 in a direction away from the power-generation element 310. The counter-electrode outer terminal 236 is a plate-shaped portion extending in the negative direction of the x-axis from a portion that the counter-electrode terminal portions 151 are not wound around and that is not covered with the counter-electrode tubular portion 337, in the end portion of the counter-electrode shaft portion 331P.

The electrode outer terminal 226 and the counter-electrode outer terminal 236 are used for electrical connection to another device. For example, in the case in which the battery 401 or 402 includes the outer case 40 illustrated in FIG. 28A or 28B, the electrode outer terminal 226 and the counter-electrode outer terminal 236 are located outside the outer case 40.

Note that the extending directions of the electrode outer terminal 226 and the counter-electrode outer terminal 236 are not limited to the examples illustrated in FIGS. 29A and 29B as in Embodiments 1 and 2. The extending directions of the electrode outer terminal 226 and the counter-electrode outer terminal 236 may be adjusted as appropriate depending on the configuration that the battery 401 or 402 is to be connected to or mounted on.

### Method of Manufacturing Battery

In the following, an example of a method of manufacturing the battery of each embodiment described above will be described.

First, a paint in a paste form in which a counter-electrode material is kneaded together with a solvent is prepared. This paint is applied to both sides of a counter-electrode current collector 150 to form counter-electrode layers 120. Next, a solid electrolyte material is applied to both sides of the counter-electrode layers 120 so as to cover the applied paint, and dried to form solid electrolyte layers 130. Note that the counter-electrode material and the solid electrolyte material may be prepared as materials not containing a solvent. Next, a paint in a paste form in which an electrode material is kneaded together with a solvent is prepared. This paint is applied to both sides of the solid electrolyte layers 130 to form electrode layers 110.

For the application method for forming the electrode layers 110, the counter-electrode layers 120, and the solid electrolyte layers 130, screen printing, die coating, spraying, gravure printing, and the like are used, but the application method is not limited to these.

Next, an electrode current collector 140 is overlaid and laminated on one of the electrode layers 110 to form a battery cell unit including two battery cells 100. A plurality of such battery cell units are prepared and laminated to form a power-generation element 10 illustrated in FIGS. 3 and 4. In this process, by adjusting the protruding directions of the electrode terminal portions 141 and the counter-electrode terminal portions 151, also the power-generation element 310 illustrated in FIG. 26 can be formed.

After a power-generation element 10 or 310 is formed, the electrode terminal portions 141 and the counter-electrode terminal portions 151 are wound around an electrode core member 20 and a counter-electrode core member 30, respectively, or a bipolar core member 350.

Alternatively, after a power-generation element 10 or 310 is formed, the electrode terminal portions 141 and the counter-electrode terminal portions 151 may be wound around an electrode shaft portion 21P and a counter-electrode shaft portion 31P, respectively. After that, an electrode tubular portion 27 is attach to the electrode shaft portion 21P such that the electrode terminal portions 141 pass through the opening 28. In addition, a counter-electrode tubular portion 37 is attach to the counter-electrode shaft portion 31P such that the counter-electrode terminal portions 151 pass through the opening 38.

In the case of the bipolar core member 350P or 450P, the electrode terminal portions 141 and the counter-electrode terminal portions 151 can be wound simultaneously around an electrode shaft portion 321P and a counter-electrode shaft portion 331P. In addition, an electrode tubular portion 27 and a counter-electrode tubular portion 37 can be attached simultaneously.

Through these processes, the battery according to each embodiment described above can be manufactured.

The manufacturing method described above is a mere example and is not limited to the method described above.

### Other Embodiments

Although the batteries according to one or more aspects have been described above on the basis of the embodiments, the present disclosure is not limited to these embodiments. Configurations made by modifying the present embodiments in various manners that those skilled in the art can come up with and configurations made by combining constituents in different embodiments are included in the scope of the present disclosure unless they depart from the spirit of the present disclosure.

For example, although the description was based on examples in which all the battery cells 100 are connected in parallel in the power-generation element 10, the present disclosure is not limited to this configuration. The power-generation element 10 may include a plurality of series units each including a specified number of laminated battery cells 100 electrically connected in series.

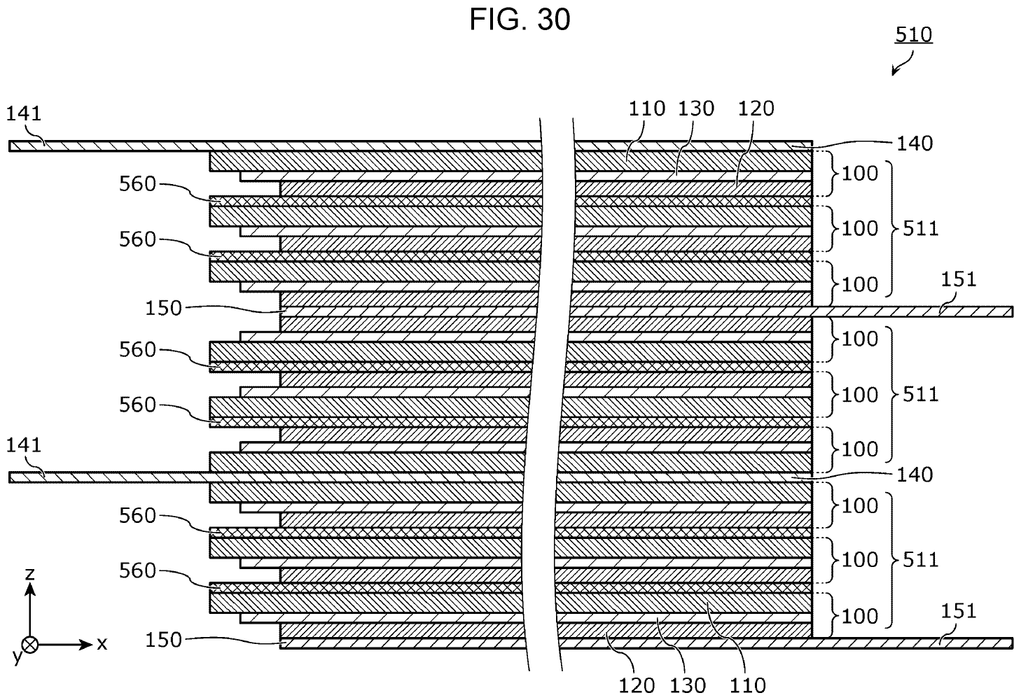

FIG. 30 is a cross-sectional view of a power-generation element 510 of a battery according to a modification example of the embodiments. As illustrated in FIG. 30, the power-generation element 510 includes a plurality of series units 511.

Each of the series units 511 includes a specified number of battery cells 100 and bipolar current collectors 560. Although the number of battery cells 100 included in each series unit 511 is three in this case, the present disclosure is not limited to this configuration. The number of battery cells 100 connected in series included in each series unit 511 may be two or four or more.

The battery cells 100 included in the series unit 511 are electrically connected in series. With attention focused on one series unit 511, the order of the layers included in each battery cell 100 is the same. For example, in FIG. 30, each battery cell 100 in the series unit 511 in the lowermost layer includes a counter-electrode layer 120, a solid electrolyte layer 130, and an electrode layer 110 laminated in this order from bottom to top. A bipolar current collector 560 is located between each pair of adjacent battery cells 100.

The bipolar current collector 560 is a member having electrical conductivity. The bipolar current collector 560 is an electrically conductive member in the form of a foil, a plate, or a mesh. The bipolar current collector 560 may be, for example, an electrically conductive thin film.

For the material of the bipolar current collector 560, for example, a metal such as stainless steel (SUS), aluminum (Al), copper (Cu), or nickel (Ni) can be used. The thickness of the bipolar current collector 560 is, for example, greater than or equal to 5 μm and less than or equal to 100 μm but is not limited to this range.

An electrode layer 110 is located on one main surface of the bipolar current collector 560, and a counter-electrode layer 120 is located on the other main surface. The bipolar current collector 560, unlike the electrode current collector 140 and the counter-electrode current collector 150, does not protrude from the battery cell 100. In other words, the bipolar current collector 560 does not have an electrode terminal portion 141 or a counter-electrode terminal portion 151. Note that the bipolar current collector 560 may protrude from the battery cell 100 unless it comes into contact with the electrode current collector 140 or the counter-electrode current collector 150.

Instead of the bipolar current collector 560, laminated electrode current collector and counter-electrode current collector may be placed. The electrode current collector and the counter-electrode current collector that can be substituted for the bipolar current collector 560 do not have an electrode terminal portion 141 or a counter-electrode terminal portion 151.

As illustrated in FIG. 30, the plurality of series units 511 are electrically connected in parallel and laminated. With attention focused on two adjacent series units 511, the laminating order of the layers included in the battery cells 100 included in the two series units 511 is opposite. In this configuration, the series units 511 can be connected in parallel easily.

Specifically, one of an electrode current collector 140 and a counter-electrode current collector 150 is located between each pair of adjacent series units 511. Although not illustrated in FIG. 30, the electrode terminal portions 141 of the electrode current collectors 140 are wound around the electrode core member 20, and the counter-electrode terminal portions 151 of the counter-electrode current collectors 150 are wound around the counter-electrode core member 30. This enables parallel connection of the plurality of series units 511, and these terminal portions function as extension portions of the electrodes and the counter electrodes.

As described above, also in the case in which the power-generation element 510 includes series units 511, the electrode terminal portions 141 and the counter-electrode terminal portions 151 can be stored compactly, as in Embodiments 1 to 3 and each modification example. Thus, it is possible to increase the energy density of the battery.

Although the power-generation element 510 illustrated in FIG. 30 is an example of a three-in-series three-in-parallel connection, the number of battery cells 100 connected in series and in parallel is not particularly limited. For example, the number of battery cells included in a power-generation element is not particularly limited and may be only one. Specifically, the power-generation element may have a single cell structure including only one battery cell.

For example, although the aforementioned embodiments are examples including rod-shaped core members, the present disclosure is not limited to this configuration. The core members may have elongated plate shapes.

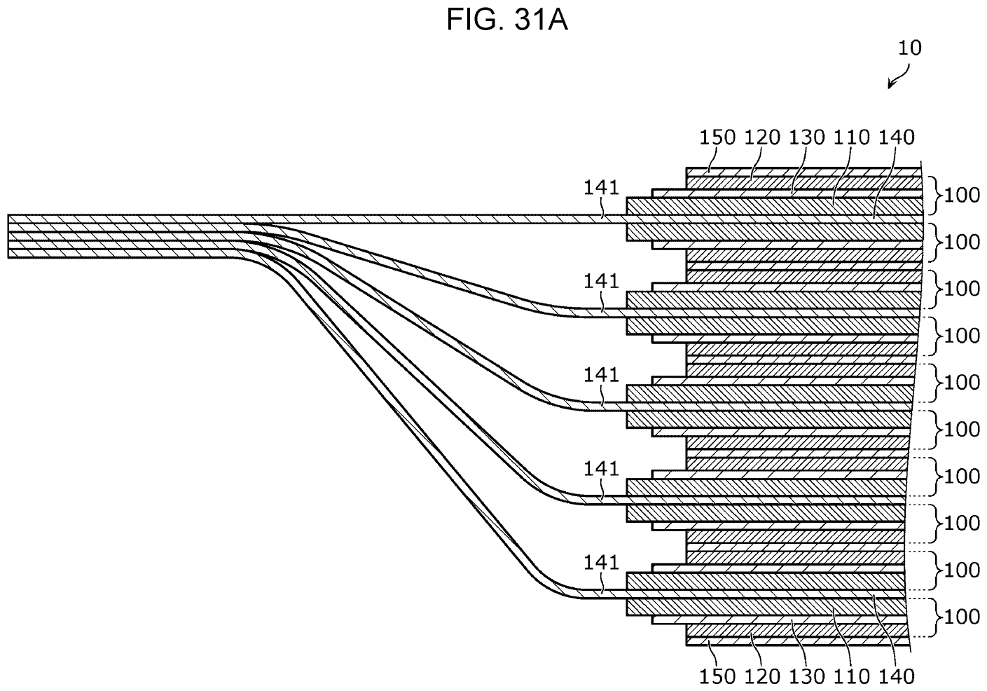

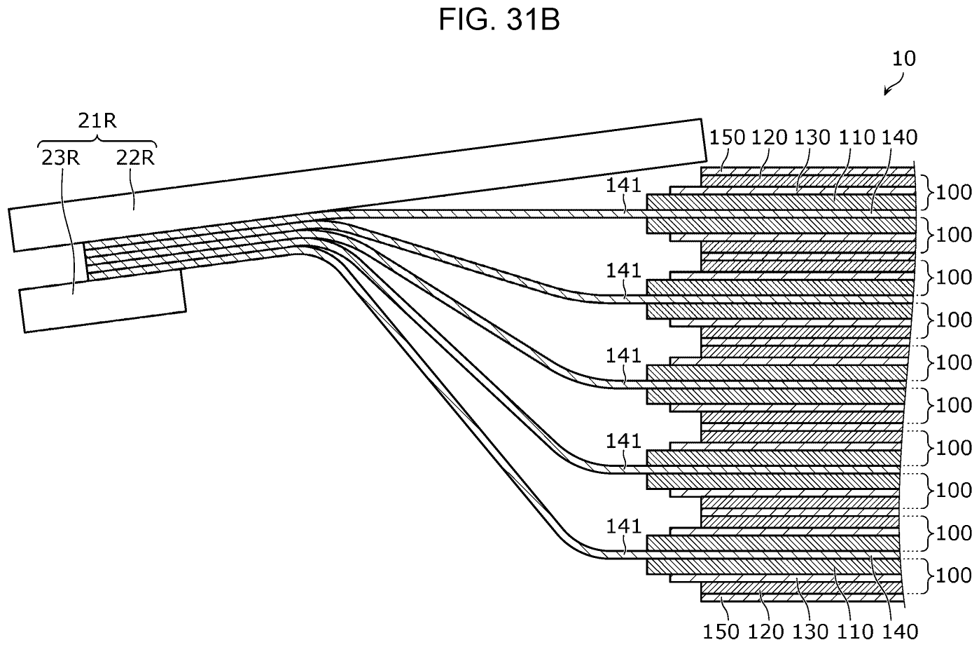

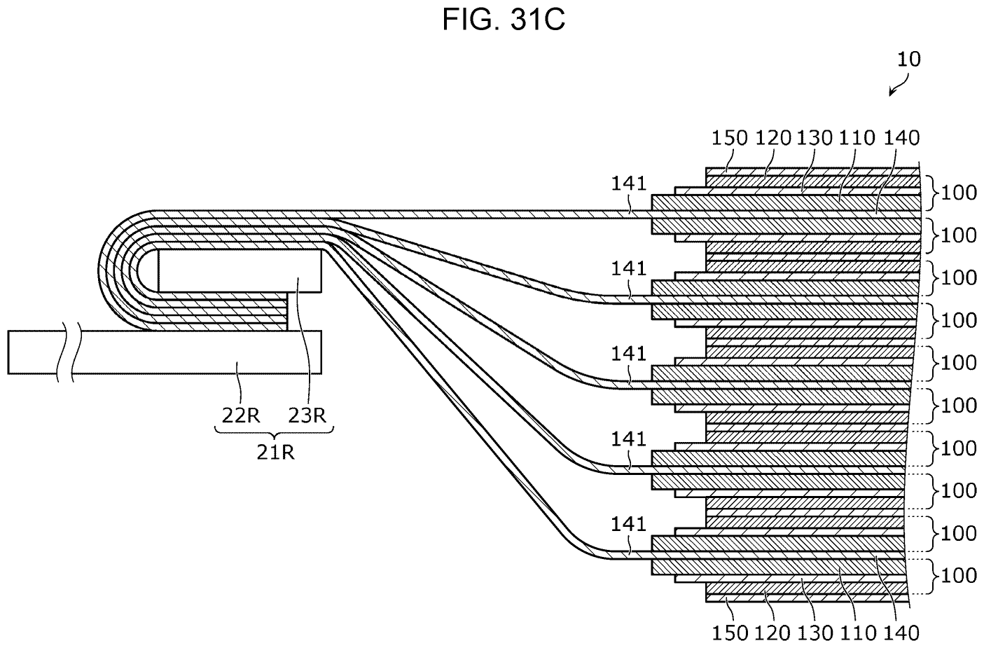

FIGS. 31A to 31C are cross-sectional diagrams for explaining steps of attaching a core member in a battery according to a modification example of each embodiment. Although the following describes an example of attaching an electrode core member, a counter-electrode core member can be attached in the same manner.

First, as illustrated in FIG. 31A, the plurality of electrode terminal portions 141 of the power-generation element 10 are bundled and held. Next, as illustrated in FIG. 31B, the plurality of electrode terminal portions 141 are placed and fixed between a first shaft member 22R and a second shaft member 23R of an electrode shaft portion 21R. The fixation is performed, for example, by welding. The first shaft member 22R is, for example, an electrically conductive extension member which is used for connection to another member such as a circuit board. The second shaft member 23R is a metal plate composed of, for example, nickel or the like.

Next in the example illustrated in FIG. 31B, the electrode shaft portion 21R is rotated counterclockwise around the end portion of the second shaft member 23R on the side of the power-generation element 10. With this operation, as illustrated in FIG. 31C, the plurality of electrode terminal portions 141 are wound around the second shaft member 23R and fixed, and the first shaft member 22R is positioned so as to extend in a direction away from the power-generation element 10.

As described above, the use of the plate-shaped electrode shaft portion 21R reduces the total thickness of the electrode shaft portion 21R. This configuration reduces the volume of the electrode shaft portion 21R and makes it possible to increase the battery capacitance.

For example, although the aforementioned embodiments are based on examples in which the electrode core member and the counter-electrode core member or the bipolar core member is located along the short sides or a short side of the power-generation element in plan view, the present disclosure is not limited to this configuration. The electrode core member and the counter-electrode core member or the bipolar core member may be located along the long sides or a long side of the power-generation element in plan view.

For example, although the aforementioned embodiments are based on examples in which the electrode core member and the counter-electrode core member are located with the power-generation element in between and with their axial directions parallel, the present disclosure is not limited to this configuration. For example, the electrode core member and the counter-electrode core member may be located along a short side and a long side of the power-generation element in plan view. Specifically, the axial directions of the electrode core member and the counter-electrode core member may be orthogonal to each other. For example, a power-generation element may include a plurality of electrode core members and a plurality of counter-electrode core members. Alternatively, a power-generation element may include a plurality of bipolar core members.

For example, although the aforementioned embodiments are based on examples in which one electrode current collector or one counter-electrode current collector is located between each pair of adjacent battery cells in the laminating direction, in other words, examples in which one electrode current collector or one counter-electrode current collector is shared by two battery cells, the present disclosure is not limited to this configuration. An electrode current collector or a counter-electrode current collector may be provided for each battery cell, and two laminated electrode current collectors or two laminated counter-electrode current collectors may be provided between two battery cells.

For example, although the aforementioned embodiments are based on examples in which each of the electrode shaft portion and the counter-electrode shaft portion is an electrically conductive member such as a metal, the present disclosure is not limited to this configuration. The electrode shaft portion and the counter-electrode shaft portion may be composed of an insulating material such as a resin having an insulating property.

For example, the shapes of the electrode outer terminal and the counter-electrode outer terminal are not limited to plate shapes and may be rod shapes or wire shapes. Alternatively, a configuration without an electrode outer terminal and a counter-electrode outer terminal is possible. In that case, for example, the electrode shaft portion and the counter-electrode shaft portion may function as outer terminals.

In the case in which the electrode tubular portion is a member having electrical conductivity, the electrode tubular portion may be used as part of a wiring path for extending the electrodes from the power-generation element. Specifically, the electrode tubular portion is in contact with and electrically connected to the electrode terminal portions, and the electrode outer terminal is connected to the electrode tubular portion. In this case, the electrode shaft portion may be formed of an insulating material. The same may apply to the counter-electrode tubular portion.

For example, although the aforementioned embodiments are based on examples in which the electrode terminal portions and the counter-electrode terminal portions are wound around the respective core members, only either the electrode terminal portions or the counter-electrode terminal portions may be wound around a core member. For example, the battery according to the present disclosure may have a configuration without a counter-electrode core member. In that case, the counter-electrode terminal portions may be connected to an extension member or the like without being wound around it. Also in a case in which only the electrode terminal portions are wound around the electrode core member, the energy density of the battery is higher than in the configuration with neither the electrode core member nor the counter-electrode core member.

For example, although the aforementioned embodiments are based on examples in which the solid electrolyte layer is uses as the separator, the present disclosure is not limited to this configuration. Instead of the solid electrolyte layer, another material not having electronic conductivity and having ionic conductivity can be used.

As for the aforementioned embodiments, various kinds of modification, replacement, addition, and omission can be made within the scope of the claims and the equivalents thereof.

The present disclosure can be used, for example, for the batteries of electronic devices, electric appliances and devices, electric vehicles, and the like.

What is claimed is:

1. A battery comprising:
a power-generation element including
a battery cell including an electrode layer, a counter-electrode layer, and
a separator located between the electrode layer and the counter-electrode layer, and
an electrode current collector laminated on the electrode layer; and
a first core member, wherein
the electrode current collector includes an electrode terminal portion protruding outside an area of the electrode layer, and
the electrode terminal portion is wound around the first core member.

2. The battery according to claim 1, further comprising
a second core member, wherein
the power-generation element includes a counter-electrode current collector laminated on the counter-electrode layer,
the counter-electrode current collector includes a counter-electrode terminal portion protruding outside an area of the counter-electrode layer, and
the counter-electrode terminal portion is wound around the second core member.

3. The battery according to claim 2, wherein
a protruding direction of the counter-electrode terminal portion differs from a protruding direction of the electrode terminal portion.

4. The battery according to claim 2, wherein
a protruding direction of the counter-electrode terminal portion is same as a protruding direction of the electrode terminal portion, and
the first core member and the second core member are integrated with an insulating member interposed in between.

5. The battery according to claim 2, wherein
the power-generation element includes a plurality of the battery cells,
the plurality of battery cells are electrically connected in parallel and laminated, and
one of the electrode current collector and the counter-electrode current collector is located between each pair of adjacent ones of the battery cells.

6. The battery according to claim 5, wherein
the power-generation element includes a plurality of the electrode current collectors and a plurality of the counter-electrode current collectors,
the electrode terminal portions of the plurality of electrode current collectors are laminated on top of one another and wound around the first core member, and
the counter-electrode terminal portions of the plurality of counter-electrode current collectors are laminated on top of one another and wound around the second core member.

7. The battery according to claim 2, wherein
the power-generation element includes a plurality of series units, each series unit including a specified number of the battery cells electrically connected in series and laminated,
the series units are electrically connected in parallel and laminated, and
one of the electrode current collector and the counter-electrode current collector is located between each pair of adjacent ones of the series units.

8. The battery according to claim 7, wherein
the power-generation element includes a plurality of the electrode current collectors and a plurality of the counter-electrode current collectors,
the electrode terminal portions of the plurality of electrode current collectors are laminated on top of one another and wound around the first core member, and
the counter-electrode terminal portions of the plurality of counter-electrode current collectors are laminated on top of one another and wound around the second core member.

9. The battery according to claim 1, wherein
the first core member includes a conductive portion electrically connected to the electrode terminal portion.

10. The battery according to claim 9, wherein
the first core member includes an outer connection terminal having electrical conductivity and extending in a specified direction from the conductive portion.

11. The battery according to claim 10, wherein
the outer connection terminal extends from an end portion in an axial direction of the first core member, in the axial direction.

12. The battery according to claim 10, wherein
the outer connection terminal extends from a surface of the first core member opposite to the power-generation element in a direction away from the power-generation element.

13. The battery according to claim 1, further comprising
an outer case housing the battery cell and the electrode current collector, wherein
at least part of the first core member is housed in the outer case.

14. The battery according to claim 1, wherein
a thickness of the first core member is smaller than a thickness of the power-generation element.

15. The battery according to claim 1, wherein
the first core member includes
a first shaft member having a first surface extending in an axial direction of the first core member and
a second shaft member having a second surface facing the first surface and extending in the axial direction, and
part of the electrode terminal portion is held between the first surface and the second surface.

16. The battery according to claim 15, wherein
the first surface has a first recess or a first protrusion, and
the second surface has a second protrusion that fits with the first recess or a second recess that fits with the first protrusion.

17. The battery according to claim 15, wherein
the first core member includes a ring-shaped member into which the first shaft member and the second shaft member are inserted with the first surface and the second surface facing each other.

18. The battery according to claim 1, wherein
the first core member has a circular cylinder shape, an elliptical cylinder shape, or a polygonal cylinder shape.

19. The battery according to claim 1, wherein
an outer peripheral side surface of the first core member has a flat surface parallel to a thickness direction of the power-generation element, on a side opposite to the power-generation element.

20. The battery according to claim 1, wherein
the separator is a solid electrolyte layer.

21. The battery according to claim 1, wherein
the first core member includes a first shaft portion and a first tubular portion in which the first shaft portion is located,
the first tubular portion has a first opening extending in an axial direction of the first shaft portion, and
the electrode terminal portion passes through the first opening and is wound around the first shaft portion.

22. A method of manufacturing a battery,
the battery including
a power-generation element including
a battery cell including an electrode layer, a counter-electrode layer, and a separator located between the electrode layer and the counter-electrode layer, and
an electrode current collector laminated on the electrode layer, and
a first core member,
the electrode current collector including an electrode terminal portion protruding outside an area of the electrode layer,
the method of manufacturing a battery comprising
winding the electrode terminal portion around the first core member.
